(19) United States
(12) Patent Application Publication
(10) Pub. No.: US 2020/0082416 A1
(43) Pub. Date: Mar. 12, 2020

(54) INFORMATION PROCESSING APPARATUS, INFORMATION PROCESSING METHOD, AND COMPUTER PROGRAM

(71) Applicant: SONY CORPORATION, TOKYO (JP)

(72) Inventor: MASATO KIMISHIMA, TOKYO (JP)

(21) Appl. No.: 16/466,802

(22) PCT Filed: Dec. 11, 2017
(86) PCT No.: PCT/JP2017/044436

§ 371 Date: Jun. 5, 2019

(30) Foreign Application Priority Data
Jan. 23, 2017 (JP) 2017-009693
Nov. 6, 2017 (JP) 2017-213650

(51) Int. Cl. G06Q 30/02; G06Q 50/00

(52) U.S. Cl. CPC G06Q 30/0201; G06Q 30/0269; G06Q 50/01; G06Q 30/0255; G06Q 30/0261

(57) ABSTRACT

Provided is an information processing apparatus capable of performing positional sameness determination of users with high accuracy without depending on environment. There is provided an information processing apparatus including a determination unit that determines similarity of positions of a plurality of users on the basis of time-series data that can identify a movement state of each of the plurality of users, obtained for each of the plurality of users.

### TECHNICAL FIELD

The present disclosure relates to an information processing apparatus, an information processing method, and a computer program.

### BACKGROUND ART

As an example of a technique for identifying a user at a specific location, Patent Document 1 discloses a technique of identifying, in a case where a plurality of users has been recognized, a user having a short distance represented by a position detected by a person position detector and a position indicated by the user's personal characteristics behavior, as a user existing at the specific location. According to the technique described in Patent Document 1, it is possible to recognize that an individual is at a specific location with no special device carried by the individual. However, in a case where the individual does not carry a special device, it is necessary to install an infrared sensor or the like at a location where recognition of the user's presence is desired, and locations where the position of the user can be identified are limited.

Meanwhile, in a case where a user's position is to be identified by the sensor included in a terminal owned by the individual, short-range wireless communication is typically used. For example, Bluetooth (registered trademark) is standard equipment in mobile communication terminals or the like, and therefore has high versatility. In addition, a general-purpose terminal such as a mobile communication terminal similarly installs a Wi-Fi positioning sensor or the Global Positioning System (GPS) as standard equipment. Accordingly, it is possible to easily identify the position of the user on the basis of measurement results of these functions.

### CITATION LIST

### Patent Document

Patent Document 1: Japanese Patent Application Laid-Open No. 2010-108037

### SUMMARY OF THE INVENTION

### Problems to be Solved by the Invention

Here, accuracy of estimating a distance between two points using Bluetooth (registered trademark) is low in a case where users at same positions are to be identified. Moreover, it is difficult to determine the distance between the two points at difference times. In contrast, with the use of a Wi-Fi positioning sensor or GPS, it would be possible, in principle, to calculate the distance between two points even at different times. Measurement accuracy in these cases, however, largely depends on the environment, and thus, the methods lack stability.

In view of this, the present disclosure proposes a novel and enhanced information processing apparatus, an information processing method, and a computer program capable of performing positional sameness determination of users with high accuracy without depending on the environment.

### Solutions to Problems

According to the present disclosure, there is provided an information processing apparatus including a determination unit that determines similarity of positions of a plurality of users on the basis of time-series data that can identify a movement state of each of the plurality of users, obtained for each of the plurality of users.

Furthermore, according to the present disclosure, there is provided an information processing method including obtaining, by using a sensor, time-series data that can be used to identify a movement state of each of a plurality of users, for each of the users; and determining, by using a processor, similarity of positions of the users on the basis of time-series data.

Furthermore, according to the present disclosure, there is provided a computer program causing a computer to function as an information processing apparatus including a determination unit that determines similarity of positions of a plurality of users on the basis of time-series data that can be used to identify a movement state of each of the plurality of users, obtained for each of the plurality of users.

### Effects of the Invention

As described above, according to the present disclosure, it is possible to perform the user positional sameness determination with high accuracy without depending on the environment. Note that the above-described effect is not necessarily limited, and it is also possible to use any one of the effects illustrated in this specification together with the above-described effect or in place of the above-described effect, or other effects that can be assumed from this specification.

### BRIEF DESCRIPTION OF DRAWINGS

FIG. 1 is a diagram illustrating an outline of positional sameness determination processing on a plurality of users performed by an information processing apparatus according to a first embodiment of the present disclosure and an outline of attribute identification processing on a plurality of users utilizing a positional sameness determination result.

FIG. 2 is a diagram illustrating one use case of attribute identification processing of a plurality of users utilizing the positional sameness determination result according to the same embodiment.

FIG. 3 is a diagram illustrating another use case of attribute identification processing of a plurality of users utilizing a result of the positional sameness determination according to the same embodiment.

FIG. 4 is a diagram illustrating another use case of attribute identification processing of a plurality of users utilizing the positional sameness determination result according to the same embodiment.

FIG. 5 is a diagram illustrating suitability of positioning by environment with respect to GPS positioning.

FIG. 6 is a diagram illustrating positioning errors during Wi-Fi positioning or base station positioning.

FIG. 7 is a diagram illustrating an error of a movement trajectory by PDR.

FIG. 8 is a diagram illustrating environment dependency of a GPS and an inertial sensor.

FIG. 9 is a functional block diagram illustrating a configuration of an information processing system according to the same embodiment.

FIG. 10 is a sequence diagram illustrating a flow of processing of the information processing system when the positional sameness determination processing according to the same embodiment is executed.

FIG. 11 is a flowchart illustrating initial setting processing in relative trajectory calculation processing according to the same embodiment.

FIG. 12 is a flowchart illustrating position calculation processing at each of times in relative trajectory calculation processing according to the same embodiment.

FIG. 13 is a flowchart illustrating absolute position information acquisition processing according to the same embodiment.

FIG. 14 is a flowchart illustrating the positional sameness determination processing according to the same embodiment.

FIG. 15 is a diagram concerning correction of deviation of a relative trajectory scale or deviation in orientation of the entire trajectory.

FIG. 16 is a diagram illustrating a relationship between a length of the buffer time of the relative trajectory and positional sameness determination accuracy.

FIG. 17 is a diagram illustrating an erroneous determination method using area determination in the positional sameness determination using a similar trajectory in another location.

FIG. 18 is a diagram illustrating an erroneous determination method by changing the buffer time of the relative trajectory in the positional sameness determination using a similar trajectory in another location.

FIG. 19 is a diagram illustrating an overview of data synchronization of a relative trajectory of a positional sameness determination target.

FIG. 20 is a diagram illustrating correspondence of relative positions of individual relative trajectories.

FIG. 21 is a diagram illustrating segmentation of time-series data on a scale unit.

FIG. 22 is a diagram illustrating scale correction of time-series data.

FIG. 23 is a diagram illustrating resampling after scale correction.

FIG. 24 is a diagram illustrating time shift correction of correcting deviation of absolute time length in each of relative trajectories.

FIG. 25 is a diagram illustrating orientation correction in each of relative trajectories.

FIG. 26 is a diagram illustrating scale correction in a relative trajectory.

FIG. 27 is a diagram illustrating position correction of a relative trajectory.

FIG. 28 is a diagram illustrating calculation of a trajectory deviation degree of the relative trajectory.

FIG. 29 is a sequence diagram illustrating a processing flow of an information processing system at execution of social attribute identification processing for a plurality of users according to the same embodiment.

FIG. 30 is a diagram illustrating a use case of the positional sameness determination in real time according to a second embodiment of the present disclosure.

FIG. 31 is a flowchart illustrating the positional sameness determination processing in real time according to the same embodiment.

FIG. 32 is a functional block diagram illustrating a configuration of an information processing system according to a third embodiment of the present disclosure.

FIG. 33 is a flowchart illustrating behavior identification processing using the location attribute table according to the same embodiment.

FIG. 34 is a diagram illustrating detection of a three-dimensional trajectory based on a detection value obtained by an atmospheric pressure sensor.

FIG. 35 is a diagram illustrating an example of a location attribute table storage unit.

FIG. 36 is a diagram illustrating population distribution over time and population distribution over staying time length as an example of location attribute information of a plurality of users existing at a same position.

FIG. 37 is a diagram illustrating matching processing between location attribute information and a location attribute table.

FIG. 38 is a diagram illustrating user's behavior identification based on the user's tweet and location attribute table update processing.

FIG. 39 is a diagram illustrating update of a location attribute table.

FIG. 40 is a diagram illustrating a social attribute table.

FIG. 41 is a block diagram illustrating a hardware configuration example of a device according to an embodiment of the present disclosure.

FIG. 42 is a diagram illustrating an example of positional sameness determination using original time-series data of a detection value of the sensor.

FIG. 43 is a diagram illustrating an example of positional sameness determination using time-series data of a detection value of an environmental sensor.

FIG. 44 is a diagram illustrating an example of an information collection agreement screen displayed on a device.

FIG. 45 is a diagram illustrating an example of an absolute time transmission agreement screen displayed on a device.

FIG. 46 is a diagram illustrating an example of a relative time transmission agreement screen displayed on a device.

### MODE FOR CARRYING OUT THE INVENTION

Hereinafter, preferred embodiments of the present disclosure will be described in detail with reference to the accompanying drawings. Note that same reference numerals are given to constituent elements having substantially a same functional configuration, and redundant description is omitted in the present specification and the drawings.

Note that the description will be given in the following order.

1. First embodiment (positional sameness determination processing and attribute identification processing)

1.1. Overview

(1) Positional sameness determination processing and attribute identification processing

(2) Positioning technology in positional sameness determination processing

1-2. Configuration of information processing system

(1) Device

(2) Server

1.3. Positional sameness determination processing

(1) Outline of processing

(2) Relative trajectory calculation processing

(3) Absolute position information acquisition processing

(4) Positional sameness determination processing

1.4. Social attribute identification processing

2. Second embodiment (realtime positional sameness determination)

3. Third embodiment (behavior identification based on location attribute table)

3-1. Configuration of information processing system

(1) Device

(2) Server

3.2. Behavior identification processing using location attribute table

(1) Area screening

(2) Positional sameness determination processing

(3) Location attribute identification processing and behavior identification processing

(4) Social attribute determination processing

4. Hardware configuration

5. Supplement

5.1. Feature amount other than relative trajectory

5.2. User agreement on information collection

### 1. First Embodiment

(1.1 Overview)

(1) Positional Sameness Determination Processing and Attribute Identification Processing

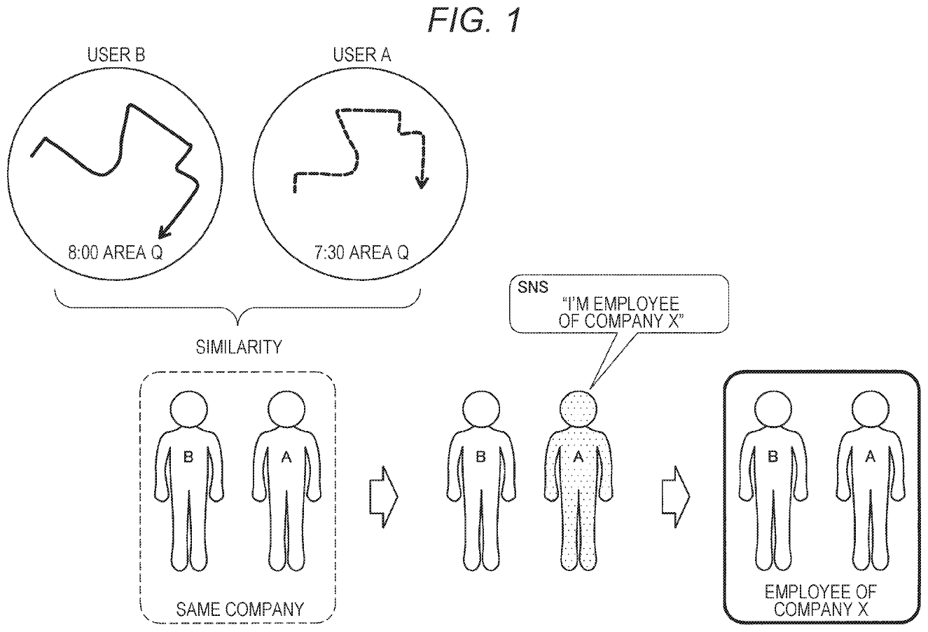

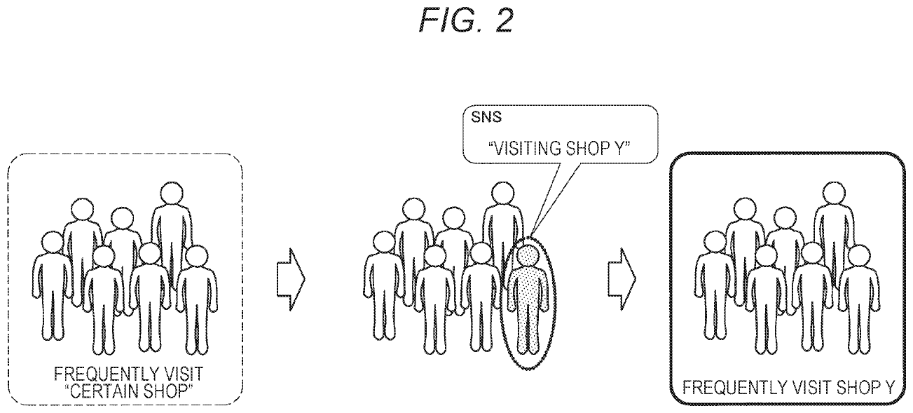

First, description will follow, with reference to FIGS. 1 to 4, on an outline of positional sameness determination processing on a plurality of users by an information processing apparatus according to a first embodiment of the present disclosure and an outline of attribute identification processing on a plurality of users utilizing a positional sameness determination result. Note that FIG. 1 is a diagram illustrating an outline of positional sameness determination processing on a plurality of users by the information processing apparatus according to the present embodiment and an outline of attribute identification processing on a plurality of users utilizing the positional sameness determination result. FIGS. 2 to 4 are diagrams illustrating another use case of attribute identification processing of a plurality of users utilizing the positional sameness determination result.

The information processing apparatus according to the present embodiment performs positional sameness determination processing of determining that a plurality of users is present at a same location and attribute identification processing of identifying specific relevance between the plurality of users on the basis of a result of the positional sameness determination processing.

The positional sameness determination processing determines users at a same position on the basis of the time-series data that can be used to identify the movement state of the users. In the present embodiment, the time-series data that can be used to identify the movement state of the user is time-series data concerning the position of the user, and is information indicating a position change (that is, a movement) of the user within a certain period. Examples of such data include time-series data of original detection values of the inertial sensor, a movement trajectory of each of users obtained on the basis of the detection value of the inertial sensor, and time-series data of absolute position information by GPS, Wi-Fi positioning, or the like, for example. The positional sameness determination processing determines presence of users at a same position at a same time or different times on the basis of such time-series data and area information used to obtain the time-series data.

It is suspected that there is a common reason and a certain relevance to be at a specific position among users who have been confirmed to be at the same position by the positional sameness determination processing. Therefore, the positional sameness determination processing cannot merely identify the users present at the same positions but also identify users having relevance.

The attribute identification processing identifies a social attribute common to a plurality of users identified to be at a same position and identified to have a certain relevance by the positional sameness determination processing. In the present embodiment, social attributes refer to social relationships such as social affiliation, positioning, and behavior. For example, examples of the social attribute include a business person's destination (company), a student's destination (school), a favorite shop or place, a place to drop by (specific shelf in a supermarket, a place where a certain dish is placed in a buffet, and the like). Furthermore, in the present embodiment, as for the social attributes, for example, information representing simply the relevance such as working for a same company is regarded as a relative value of the social attribute, and specific information that indicates working for a company X, for example, is regarded as an absolute value.

In the attribute identification processing, social attribute of each of users is identified on the basis of the social attribute obtained from at least one user among a plurality of users identified to have some relevance to each other. The relative value of the user's social attribute may be identified by the area and time zone in which the user is located, by behavior recognition information, or the like. In contrast, the absolute value of the user's social attribute may be identified by absolute position information obtained by GPS, Wi-Fi positioning, or the like, or may be identified by absolute information revealed by a certain user on SNS or the like. Note that the absolute position information is one of absolute information. After identification of the absolute value of the social attribute is obtained for at least one user, the absolute value of the social attribute can also be identified for other users having a same relative value of the social attribute.

For example, as illustrated in FIG. 1, it is assumed to have obtained a movement trajectory of a user A in an area Q at 8:00 and a movement trajectory of a user B in the area Q at 7:30. These movement trajectories are determined to be similar by the positional sameness determination processing. Furthermore, it is assumed here that the relative value of the social attribute that the users A and B work for the same company is identified from information that the time zone in which these movement trajectories have been obtained is a commuting time zone in weekday mornings and that the users A and B exit in a same building during daytime on weekdays.

After identifying the relative value of the social attributes of the user A and the user B, obtaining an absolute value of the social attribute for either one of the user A or the user B would lead to acquisition of the absolute value of the social attribute for the other users as well. For example, as illustrated in FIG. 1, here is an exemplary state where the relative value of the social attribute that the users A and B work for the same company has been identified, and the user A reveals on SNS that he or she is an employee of the company X, for example, it is possible to identify the user B working for the same company as user A as an employee of the company X. In this manner, the attribute identification processing makes it possible to identify attributes of a plurality of users having some relevance on the basis of absolute information of a certain user. Furthermore, with acquisition of identification of the relative value of the social attribute of another user, that is, the fact that the other user is working for the same company as the user A, the other user can also be identified as an employee of the company X.

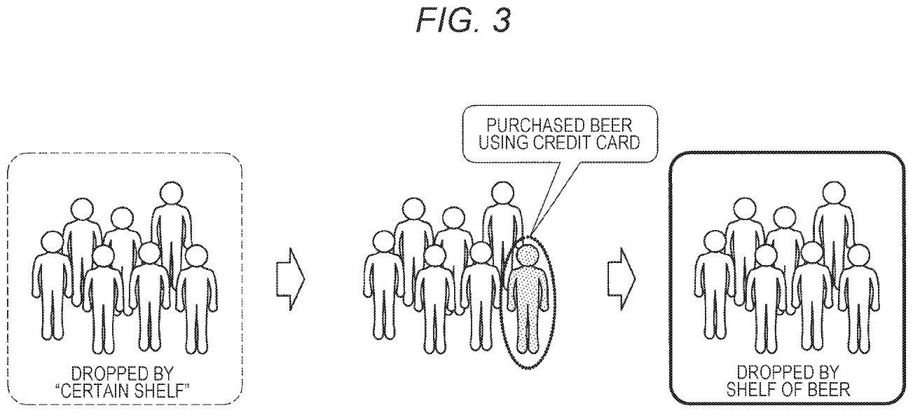

Similarly, as illustrated in FIG. 2, here is an exemplary case where a relative value of a social attribute of frequently visiting “a certain shop” has been obtained for a plurality of users. At this time, specific information that one of the users is “in shop Y” revealed by the user would lead to acquisition of information that the other users having the same relative value of social attributes with the user also “frequently visit shop Y”. Furthermore, as illustrated in FIG. 3, for example, it is assumed that a relative value of a social attribute of having dropped by “a certain shelf” in a supermarket has been obtained for a plurality of users. At this time, information that one of the users “purchased beer with a credit card” would lead to acquisition of information that the other users having the same relative value of social attribute as the user also “dropped by the shelf of beer”. In this manner, it is possible to identify an absolute value of a social attribute of a user from a purchase history by credit card settlement, and it is also possible to identify an absolute value of a social attribute of another user having the same relative value of a social attribute as the user whose absolute value of the social attribute has been identified. In addition, an absolute value of a social attribute, such as “the shelf where a user frequently drops by” can also be utilized for grasping purchasing behavior and preference of the user.

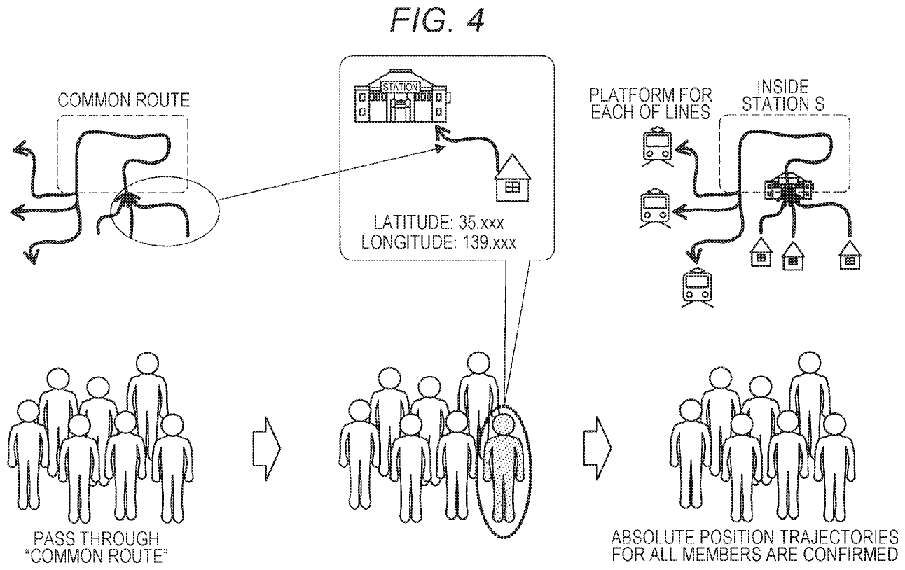

Furthermore, as illustrated in FIG. 4, here is another example in which relevance of traveling via a “certain common route” is known for a plurality of users. At this time, acquisition of an absolute position before reaching the common route for one user can lead to identification of an absolute position for the common route, making it possible to identify an absolute position of another route connected to the common route. For example, it is assumed that an absolute position trajectory of a route used by a certain user (trajectory represented by latitude and longitude) has been accurately obtained by GPS. At this time, origin and destination of the route may be identified on the basis of GPS information and map information. For example, it is assumed that the route for which an absolute position trajectory has been obtained is a route from the user's house to a station S, being a route connected to the common route. At this time, the absolute position trajectory of the common route is identified from the route for which the absolute position trajectory has been identified, and furthermore, an absolute position trajectory of another route connected to the common route can also be identified. For example, it is possible to identify a specific route including a fact that the common route is within the station S and another route connected to the common route is a route chosen by the user to change trains at the station S. Additionally, regarding other users having relevance to the user, identification of the absolute position trajectory of the common route would lead to identification of the absolute position trajectory of the route of each of the users connected to the common route. Furthermore, it is also possible to identify the location of the user's house on the basis of the staying time length of the user or the like.

In this manner, from the result of the positional sameness determination processing, it is possible to identify the fact that a plurality of users is at the same position, and that some relevance exists among the plurality of users. Furthermore, it is possible to identify relative values or absolute values of social attributes on the basis of time, area information, user's absolute information revealed in SNS regarding users having relevance, or the like. These results might be used to enable acquisition of useful information with data mining.

(2) Positioning Technology in Positional Sameness Determination Processing

In order to accurately identify a plurality of users having relevance by sharing a same position, the accuracy of the positioning technology for positioning the user has importance. With an ideal positioning technology enabling positioning with high accuracy and a small delay regardless of indoor or outdoor, it is possible to perform positional sameness determination of users by a simple technique of obtaining “whether or not positions of N persons are close to each other at a specific time”. However, there are various restrictions on the positioning technology that is generally utilized at present.

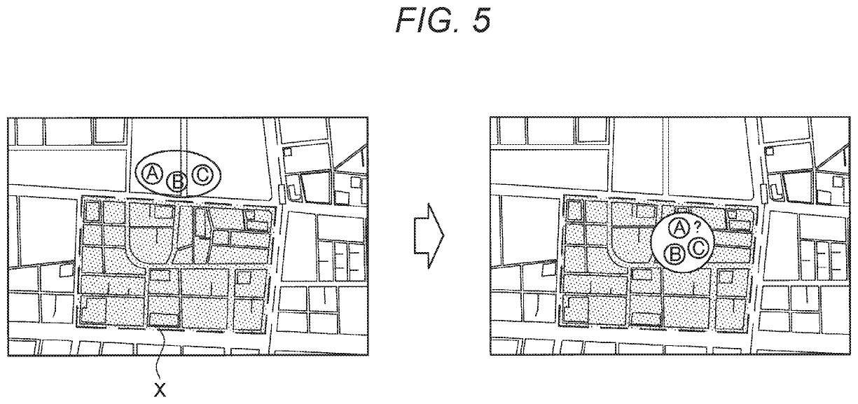

For example, as in the left illustration of FIG. 5, GPS positioning can measure the position of the user existing outdoors with high accuracy. However, even when the user is outdoors, GPS positioning errors increase at locations surrounded by high-rise buildings or the like (for example, area X) such as a street with many high-rise buildings. Furthermore, GPS positioning indoors is substantially impractical as in the right illustration of FIG. 5. In this manner, GPS positioning heavily depends on the environment.

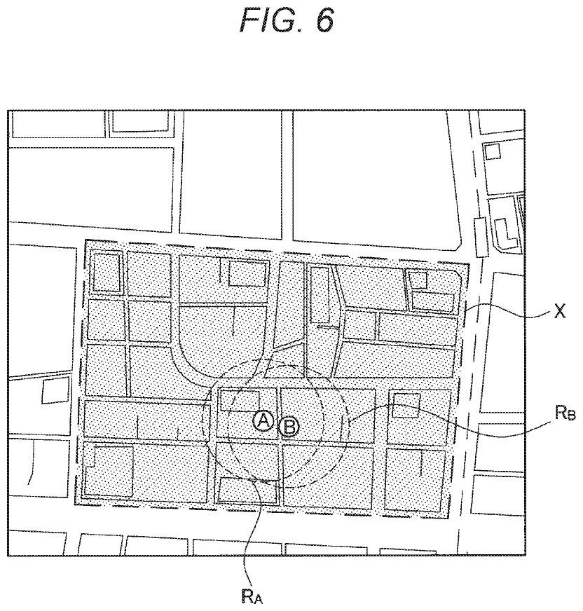

Meanwhile, Wi-Fi positioning or base station positioning can perform indoor positioning. However, Wi-Fi positioning or base station positioning generally includes large positioning errors as illustrated in FIG. 6, in which positioning results of users A and B include positioning errors of radii R_{A} and R_{B}, respectively. Furthermore, in order to enhance the positioning accuracy, it is necessary to reinforce infrastructure, making it difficult to implement positional sameness determination of plurality of users at low cost.

Meanwhile, in recent years, pedestrian dead reckoning (PDR) has attracted attention as indoor positioning technology. The PDR is a relative positioning technology that estimates a user's traveling direction and moving distance on the basis of a change in a detection value of inertial sensors such as an acceleration sensor, an angular velocity sensor, and a gyro sensor, mounted on a device worn by the user. Accordingly, the absolute position and the absolute orientation of the user are estimated on the basis of a positioning result of the PDR with reference to the absolute position and the absolute orientation obtained by GPS or the like. Normally, indoor positioning by the PDR is performed on the basis of GPS positioning information (absolute position and absolute orientation) obtained immediately before entrance of the user, and an absolute position is estimated on the basis of a positioning result measured by PDR after user's entrance indoors. That is, accuracy of the absolute position and the absolute orientation estimated from the positioning result of the PDR depends on the accuracy of the GPS positioning information obtained immediately before the user's entrance, and the orientation error depends, in particular, to the estimated absolute orientation.

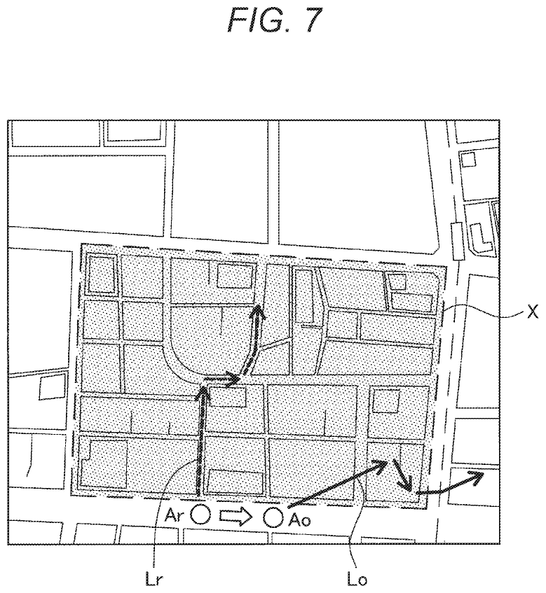

However, the accuracy of the GPS before user's entrance indoors is low, and PDR positioning accuracy cannot be sufficiently achieved in some cases due to an error in GPS positioning information. For example, as illustrated in FIG. 7, when there is an error in the GPS positioning information obtained immediately before the user enters an area X with respect to a movement trajectory Lr from an actual position Ar of a user A in the area X, a position Ao measured by GPS would deviate from an actual position Ar. Moreover, a movement trajectory Lo of the user A estimated from the PDR positioning result with reference to the positioning position Ao would also deviate from an actual movement trajectory Lr as illustrated in FIG. 7, leading to a failure in identifying a correct movement trajectory.

In this manner, the positioning accuracy depends on the environment or the infrastructure in the positioning technology generally utilized at present. Accordingly, there is some limitation in executing positional sameness determination for a plurality of users simply and with high accuracy on the basis of the positioning results would have limitation. In view of this, the present embodiment proposes a method for performing positional sameness determination of users simply and with high accuracy without depending on the environment such as outdoor or indoor. Specifically, on the basis of time-series data of detection values obtained by sensors capable of identifying user's movement states and capable of achieving accuracy independent of the environment, positional sameness determination of a plurality of users is performed from the similarity of the time-series data. Alternatively, it is also possible to obtain relative trajectories for a fixed time from the time-series data and determine the similarity of the relative trajectories, and may thereby perform positional sameness determination on the plurality of users.

Examples of sensors capable of achieving accuracy independent of the environment include inertial sensors such as an acceleration sensor, an angular velocity sensor, and a gyro sensor. Note that, strictly speaking, sensor characteristics vary slightly with a temperature change, but, a large temperature change would not occur in a state where the device including an inertial sensor is worn on the human body, and fluctuation due to the environment is negligible. Furthermore, with the use of an inertial sensor with small temperature dependence, it is possible to suppress fluctuation in sensor characteristics due to environmental changes.

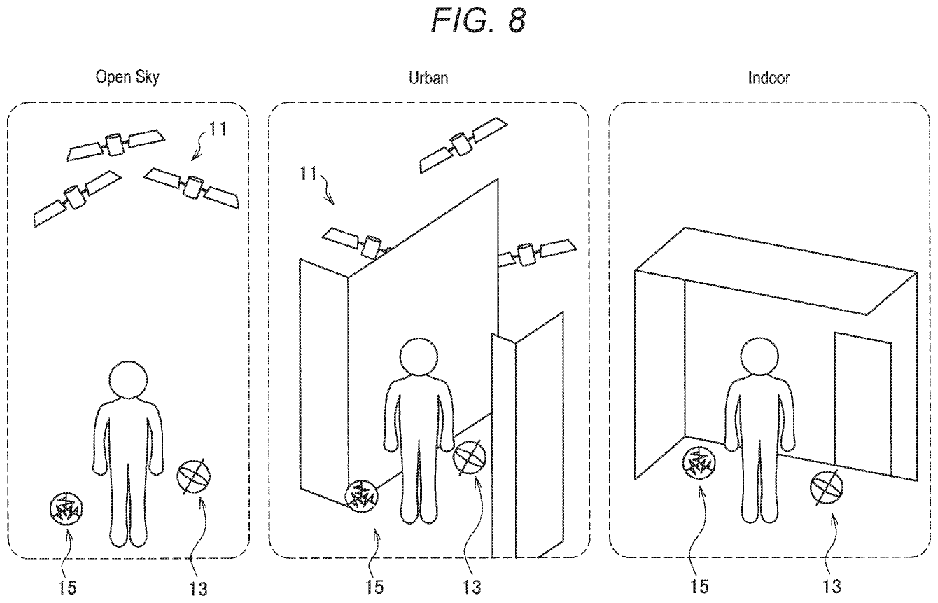

Inertial sensors are generally mounted on almost all devices that are held or worn by many users, such as smartphones and wearable terminals. Accordingly, there is no need to use a special device in order to perform the positional sameness determination by a plurality of users according to the present embodiment. In addition, GPS or Wi-Fi used to identify an user's absolute position is almost installed in these devices similarly to the inertial sensor. As illustrated in FIG. 8, at open outdoor, it would be possible to perform positioning with high accuracy even with the GPS 11, the gyro sensor 13, or the acceleration sensor 15. As opposed to this, in the high-rise building streets or indoors of an urban area, the gyro sensor 13 and the acceleration sensor 15 can stably perform positioning with high accuracy independent of the environment, although positioning with the GPS 11 can be performed with low positioning accuracy, or cannot be performed at all.

Hereinafter, the present embodiment will describe positional sameness determination processing of a plurality of users performed on the basis of the relative trajectory of a fixed time based on time-series data of detection values of an inertial sensor obtained for each of users. Furthermore, the social attribute identification processing of a plurality of users based on the result obtained by the positional sameness determination processing will be described.

(1-2. Configuration of Information Processing System)

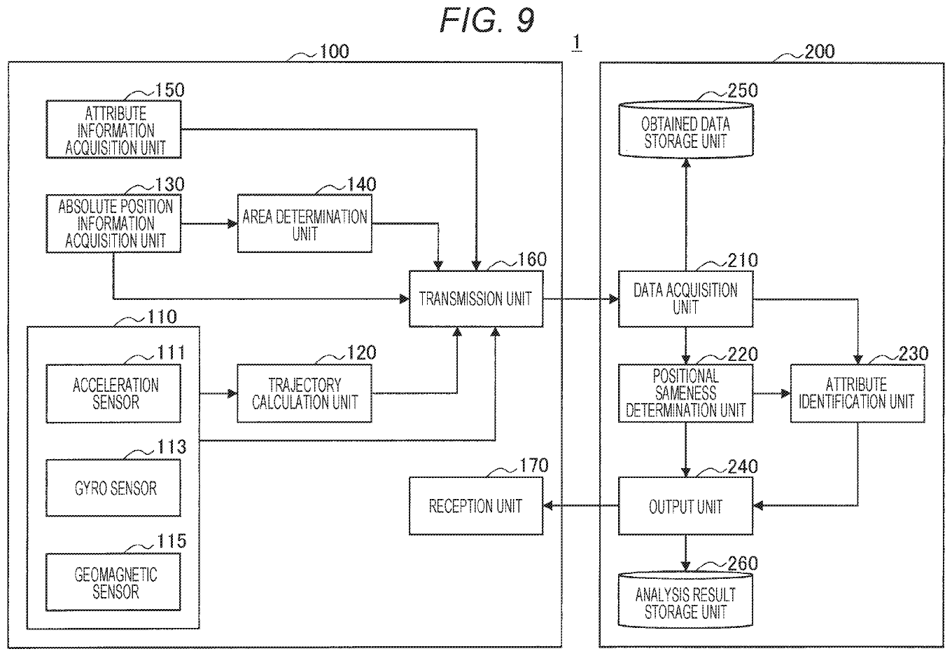

Prior to the explanation of positional sameness determination processing and social attribute identification processing according to the present embodiment, an information processing system 1 that performs the processing will be first described with reference to FIG. 9. FIG. 9 is a functional block diagram illustrating a configuration of the information processing system 1 according to the present embodiment.

As illustrated in FIG. 9, the information processing system 1 according to the present embodiment includes: a device 100 held by a user; and a server 200 that executes positional sameness determination processing and attribute identification processing on the basis of information obtained by the device 100. Although FIG. 9 illustrates one device 100 alone, the server 200 is connected to the device 100 held by each of a plurality of users. The server 200 executes positional sameness determination processing and attribute identification processing on the basis of data received from a plurality of devices 100.

(1) Device

The device 100 is an information processing terminal held by a user, such as a smartphone and a wearable terminal. As illustrated in FIG. 9, the device 100 includes a sensor unit 110, a trajectory calculation unit 120, an absolute position information acquisition unit 130, an area determination unit 140, an attribute information acquisition unit 150, a transmission unit 160, and a reception unit 170.

The sensor unit 110 includes one or more sensors capable of detecting attitude and movement of the device 100 and includes, for example, inertial sensors such as an acceleration sensor 111 and a gyro sensor 113. Furthermore, the sensor unit 110 may include an environmental sensor such as a geomagnetic sensor 115. In addition to these sensors, the sensor unit 110 may include an angular velocity sensor or the like as an inertial sensor, and may include an atmospheric pressure sensor, a temperature sensor, a humidity sensor, and a wind velocity sensor as environmental sensors, a microphone, a camera, or the like. The detection value of each of the sensors of the sensor unit 110 is output to the trajectory calculation unit 120. Note that the sensor unit 110 may output time-series data of the detection value of each of the sensors to the transmission unit 160 so that the original time-series data can be transmitted from the transmission unit 160 to the server 200.

The trajectory calculation unit 120 calculates a relative trajectory of a user holding the device 100 on the basis of the detection value input from the sensor unit 110. When at least detection values of the acceleration sensor 111 and the gyro sensor 113 can be obtained among the sensors of the sensor unit 110, the trajectory calculation unit 120 can calculate the relative trajectory. The calculation processing of the relative trajectory by the trajectory calculation unit 120 will be specifically described later. The trajectory calculation unit 120 outputs the calculated relative trajectory to the transmission unit 160.

The absolute position information acquisition unit 130 obtains absolute position information of the device 100. The absolute position information acquisition unit 130 is, for example, a GPS receiver, a Wi-Fi reception unit, or the like. The absolute position information acquisition unit 130 outputs the obtained absolute position information of the device 100 to the area determination unit 140. Note that the absolute position information obtained by the absolute position information acquisition unit 130 may be directly output to the transmission unit 160.

The area determination unit 140 determines an area where the device 100 is located on the basis of the absolute position obtained by the absolute position information acquisition unit 130. The area to be identified by the area determination unit 140 is supposed to have been preliminarily set. In the present embodiment, the area where the user (the device 100 in practice) exists is utilized as information for avoiding erroneous determination in the positional sameness determination. For this reason, high determination accuracy is not required for area determination, and it is sufficient as long as an approximate position represented in the range of about several tens of meters can be identified. The area determination unit 140 outputs the determined area to the transmission unit 160.

The attribute information acquisition unit 150 obtains information that can be used to identify a social attribute or a social attribute of the user. For example, the attribute information acquisition unit 150 obtains information regarding the relative value or the absolute value of the social attribute revealed by the user from, for example, information stored in the device 100, information input using the device 100, or the like. Alternatively, the attribute information acquisition unit 150 may identify the relative value or the absolute value of the user's social attribute from the behavior of the user. For example, it is allow to use the purchased item from the purchase history of the user's credit card settlement for this purpose. The relative value or absolute value of the user's social attribute obtained by the attribute information acquisition unit 150 is used to identify a social attribute of another user determined to have some relevance to the user. Note that absolute position information obtained by the absolute position information acquisition unit 130 can also be utilized as information to identify the social attribute of the user.

The transmission unit 160 transmits various types of information input from the sensor unit 110, the trajectory calculation unit 120, the absolute position information acquisition unit 130, the area determination unit 140, and the attribute information acquisition unit 150, to the server 200.

The reception unit 170 receives various types of information transmitted from the server 200. The information received by the reception unit 170 is processed as appropriately for individual purposes, for example, displayed on a display unit (not illustrated) provided in the device 100, recorded in a storage unit (not illustrated), or the like.

(2) Server

The server 200 performs positional sameness determination of determining whether or not users exist (existed) at a same position on the basis of information input from the device 100 of each of the users. Furthermore, the server 200 according to the present embodiment is assumed to be also capable of executing social attribute identification processing of identifying social attributes of a plurality of users on the basis of results of the positional sameness determination. As illustrated in FIG. 9, the server 200 includes a data acquisition unit 210, a positional sameness determination unit 220, an attribute identification unit 230, an output unit 240, an obtained data storage unit 250, and an analysis result storage unit 260.

The data acquisition unit 210 receives various types of information from a plurality of the devices 100 that can communicate with the server 200. The data acquisition unit 210 obtains detection values of individual sensors of the sensor unit 110, a relative trajectory of a user calculated by the trajectory calculation unit 120, absolute position information obtained by the absolute position information acquisition unit 130, and area information identified by the area determination unit 140. These pieces of information are used for positional sameness determination processing and are output to the positional sameness determination unit 220. Furthermore, for the social attribute determination processing, the data acquisition unit 210 can also obtain the social attribute of the user, or information that can be used to identify the social attribute, obtained by the attribute information acquisition unit 150. Such information is output to the attribute identification unit 230. Furthermore, the data acquisition unit 210 may record the obtained various types of information in the obtained data storage unit 250.

The positional sameness determination unit 220 determines users existing at a same position. The positional sameness determination unit 220 according to the present embodiment determines the similarity of the relative trajectory of each of users and determines whether or not the users exist at a same position. The positional sameness determination unit 220 may function as a functioning unit that implements functions of: a synchronization processing unit that performs data synchronization of the positional sameness determination target; a deviation degree calculation unit that calculates a degree of deviation of the synchronized time-series data; and a determination processing unit that performs positional sameness determination of the users on the basis of calculated deviation degree. Note that specific positional sameness determination processing performed by the positional sameness determination unit 220 will be described later in detail. The positional sameness determination unit 220 outputs the determination result to the output unit 240. Note that the determination result may be output to the attribute identification unit 230.

The attribute identification unit 230 identifies social attribute of the users determined to have some relevance by their presence at a same position by the positional sameness determination processing. After acquisition of information that can be used for identifying the social attribute or the social attribute of at least one user, the attribute identification unit 230 identifies social attributes of all users having relevance on the basis of the information. The attribute identification unit 230 outputs the identified social attribute to the output unit 240.

The output unit 240 transmits information to the device 100 connected to the server 200. For example, the output unit 240 may output a result of determination by the positional sameness determination unit 220 and the user's social attribute identified by the attribute identification unit 230, to the device 100 of the user as a notification target. Furthermore, the output unit 240 may record the processing result of the server 200 in the analysis result storage unit 260.

The obtained data storage unit 250 is a storage unit that stores various pieces of information obtained from each of the devices 100. The analysis result storage unit 260 is a storage unit that stores the processing result in the server 200. The information held in these storage units can also be utilized for data mining or the like.

The configuration of the information processing system 1 according to the present embodiment has been described above. Note that while the present embodiment is an example in which the positional sameness determination processing and social attribute identification processing are executed by one server 200, the present disclosure is not limited to this example. The positional sameness determination processing and social attribute identification processing may be configured to be executed by different servers, or at least one of the processing may be configured to be executable by the device 100. Furthermore, although the area determination unit 140 is included in the device 100, the present disclosure is not limited to this example, and may be included in the server 200.

(1.3. Positional sameness determination processing)

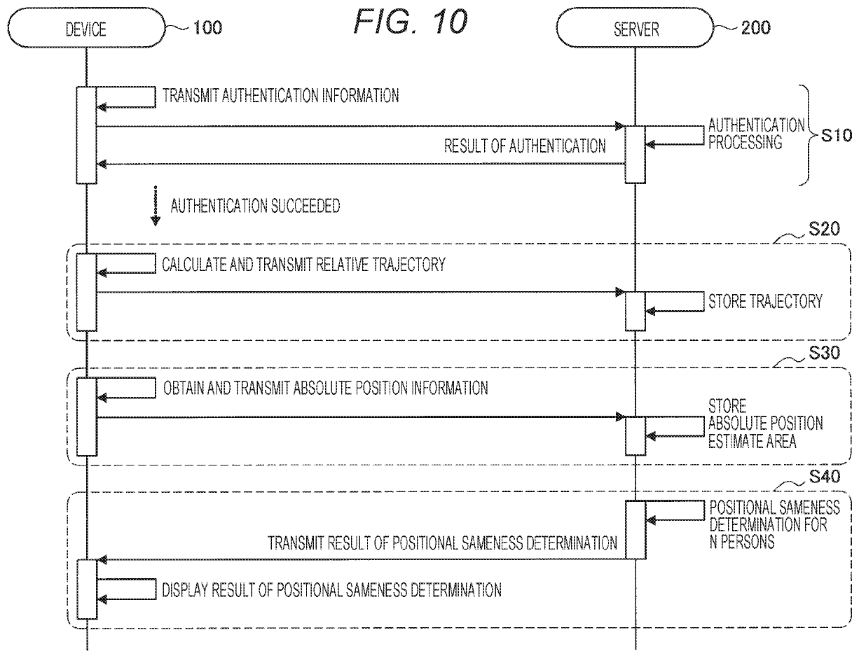

Next, positional sameness determination processing according to the present embodiment will be described with reference to FIGS. 10 to 27.

(1) Outline of Processing

First, with reference to FIG. 10, an outline of the processing when the positional sameness determination processing is executed will be described. FIG. 10 is a sequence diagram illustrating a flow of processing of the information processing system 1 when the positional sameness determination processing according to the present embodiment is executed. This processing is started from user authentication processing (S10). After transmission of the authentication information from the user's device 100 to the server 200, the server 200 executes authentication processing on the basis of the authentication information, and transmits a result of the authentication to the device 100. In a case where the user is authenticated, the processing of steps S20 to S40 will be executed on the device 100 and the server 200.

After authentication of the authentication information, the device 100 executes processing of obtaining various types of information used for positional sameness determination processing and outputting the information to the server 200. More specifically, the relative trajectory acquisition processing (S20) and absolute position information acquisition processing (S30) are executed. Step S20 and step S30 are executed independently, executed at individual timings at which necessary information is obtained.

In the relative trajectory acquisition processing, the relative trajectory is calculated by the trajectory calculation unit 120 on the basis of the detection value of the sensor unit 110 of the device 100. The calculated relative trajectory is transmitted to the server 200 via the transmission unit 160 and recorded in the obtained data storage unit 250. Details of the relative trajectory calculation processing by the trajectory calculation unit 120 will be described later.

In the absolute position information acquisition processing, the device 100 transmits the absolute position information obtained by the absolute position information acquisition unit 130 to the server 200 via the transmission unit 160. The server 200 records the received absolute position information of the device 100 in the obtained data storage unit 250. Furthermore, in the positional sameness determination processing, the server 200 identifies an area to which the absolute position information belongs. Note that while FIG. 10 is an example in which the server 200 has a function of the area determination unit, and the server 200 identifies the area, the present disclosure is not limited to this example. As illustrated in FIG. 9, in a case where the device 100 includes the area determination unit 140, area identification may be performed on the device 100 side and the device 100 may notify the server 200 of the identified area together with the absolute position information.

The relative trajectory acquisition processing (S20) and the absolute position information acquisition processing (S30) are executed between the devices 100 of the plurality of users and the server 200. Moreover, when information regarding the plurality of users is obtained for a predetermined period or more, the positional sameness determination processing (S40) of users by the server 200 can be executed. The positional sameness determination processing may be executed at a point where the processing can be executed or may be executed at predetermined cycle timing (for example, daily) on the premise that the processing can be executed. The server 200 may transmit the determination result of the positional sameness determination processing to each of the devices 100 as necessary. The device 100 that has received the determination result of the positional sameness determination processing may display the determination result on the display unit, and may notify the user, for example.

The above is the outline of the processing when the positional sameness determination processing is executed. Hereinafter individual processing will be described in detail.

(2) Relative Trajectory Calculation Processing

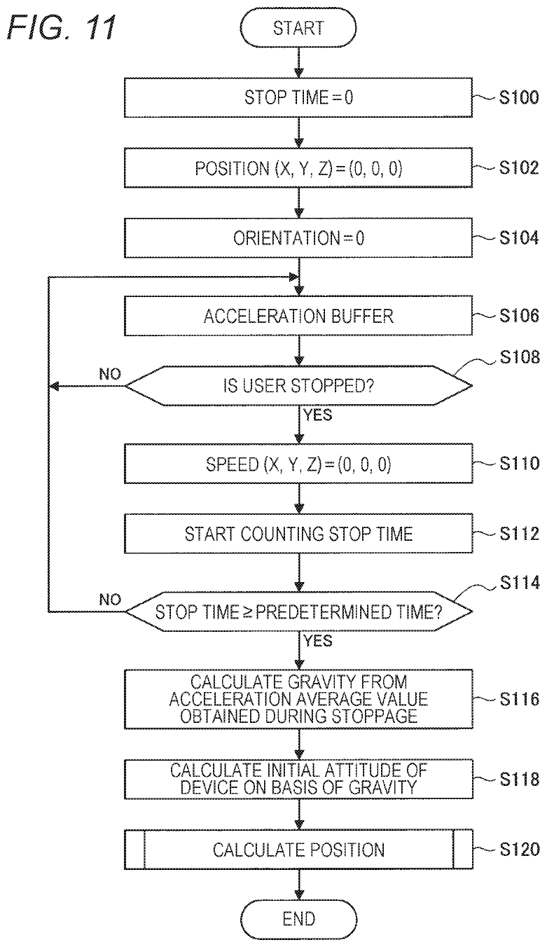

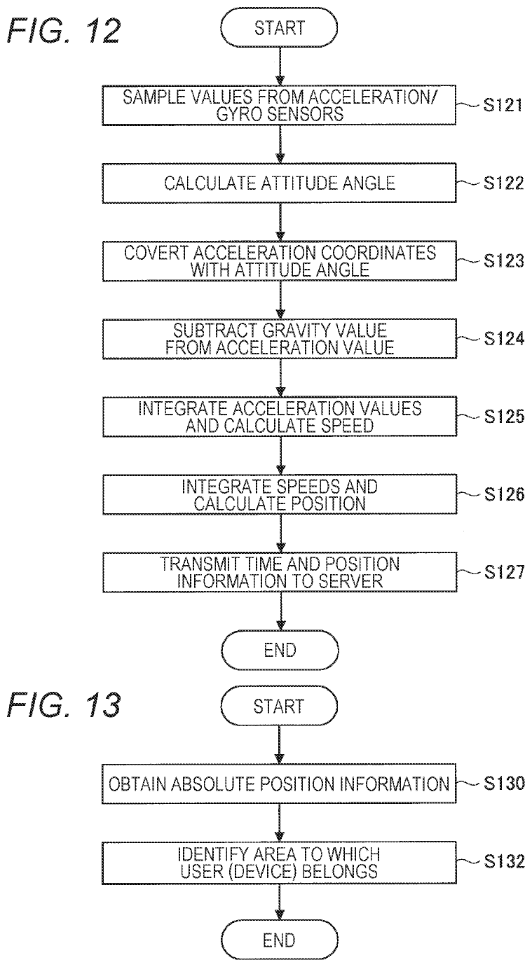

Calculation of the relative trajectory performed in the relative trajectory acquisition processing (S20) of FIG. 10 may be performed by processing illustrated in FIGS. 11 and 12, for example. FIG. 11 is a flowchart illustrating initial setting processing in the relative trajectory calculation processing. FIG. 12 is a flowchart illustrating position calculation processing at each of times in the relative trajectory calculation processing.

The trajectory calculation unit 120 of the device 100 according to the present embodiment calculates a movement trajectory of the user as a relative trajectory obtained on the basis of the detection value obtained by the inertial sensor. In the present embodiment, a case where the relative trajectory is calculated by PDR will be described. In acquisition of the relative trajectory, initial attitude to be the reference is first determined in the initial setting processing. Thereafter, the position at each of times is calculated and the moving distance and the moving direction from the initial attitude are identified.

Specifically, in order to identify the initial attitude, the stop time, the position and the orientation at the start of the initial setting processing illustrated in FIG. 11 are first set to zero (S100 to S104). The stop time refers to the time during which the device 100 has been continuously in a state having no (substantially zero) acceleration change. The position and orientation are the relative position and the relative direction.

Next, the trajectory calculation unit 120 refers to the detected value of the buffered acceleration sensor 111 (S106) and determines whether or not the user is stopped from the change in the detected value (S108). Since the initial attitude is set on the basis of the acceleration at the time of stop, it is necessary to confirm that the user is stopped. The user stop determination may be performed, for example, by whether or not the acceleration is obtained for a predetermined time (for example, one second) or more and the variance value of the obtained acceleration is a predetermined value or less. In a case where the variance value is larger than the predetermined value and does not satisfy the stop determination condition, the processing returns to step S106 and the processing from step S106 is executed again. In contrast, in a case where it is determined in step S108 that the variance value is the predetermined value or less, the trajectory calculation unit 120 determines that the user is stopped, sets the moving speed of the user at that time to zero (S110), and then, starts counting stop time (S112).

Thereafter, it is determined whether or not the stop time has reached a predetermined time (for example, five seconds) or more (S114). In a case where the stop time is shorter than the predetermined time, the processing returns to step S106, and the processing from step S106 is executed again. In contrast, in a case where the stop time is the predetermined time or more in step S114, gravity is calculated from a time average value of acceleration obtained by the acceleration sensor 111 during stoppage (S116), and initial attitude of the device 100 is calculated from the calculated gravity (S118). When the initial attitude of the device is determined in step S118, processing of calculating the position of the device 100 at each of times and obtaining the relative trajectory is executed in step S120.

In the position calculation processing, as illustrated in FIG. 12, first, detection values of the acceleration sensor 111 and the gyro sensor 113 are obtained (S121), and an attitude angle is calculated on the basis of the detection value of the gyro sensor 113 (S122). Subsequently, an acceleration coordinate system is converted with the attitude angle calculated in step S122, and a local coordinate system is converted into the global coordinate system (S123). Thereafter, the gravity value is subtracted from the acceleration value detected by the acceleration sensor 111 (S124). Integrating the acceleration from which the gravity value has been removed makes it possible to obtain the moving speed of the user (S125). Furthermore, integrating the moving speed calculated in step S125 would also make it possible to obtain position information (S126). The trajectory calculation unit 120 transmits the position information obtained in this manner and the time of the position information to the server 200. Executing the position calculation processing illustrated in FIG. 12 at each of times would lead to acquisition of time-series data of the position information, namely, a relative trajectory. Note that the processing illustrated in FIGS. 11 and 12 is the same as the general inertial navigation calculation processing, and thus, the relative trajectory may be calculated by another method.

(3) Absolute Position Information Acquisition Processing

The acquisition of the absolute position information performed in the absolute position information acquisition processing (S30) in FIG. 10 may be performed by the processing illustrated in FIG. 13, for example. At this time, the area where the user is located may be identified on the basis of the absolute position information. FIG. 13 is a flowchart illustrating absolute position information acquisition processing.

The absolute position information is obtained by the absolute position information acquisition unit 130 of the device 100 (S130). Examples of the absolute position information include positioning information by GPS, positioning information by Wi-Fi, positioning information by communication with a mobile phone base station, or the like. The absolute position information can be obtained as long as the device 100 is connectable to their own network.

Furthermore, the area determination unit 140 may identify the area where the device 100 is located on the basis of the absolute position information (S132). The area may be identified on the basis of correspondence information between a preliminarily set absolute position and an area, for example.

The absolute position information obtained in step S130 and the area obtained in step S132 are output to the server 200 via the transmission unit 160. As described above, the area identified by the absolute position information in the present embodiment is utilized as information for avoiding erroneous determination of the positional sameness determination. For this reason, high determination accuracy is not required for area determination, and it is sufficient as long as an approximate position represented in the range of about several tens of meters can be identified. Therefore, the absolute position information acquisition processing may be executed and the information obtained by this processing may be used even in an environment where the measurement error of the absolute position information is large.

(4) Positional sameness determination processing

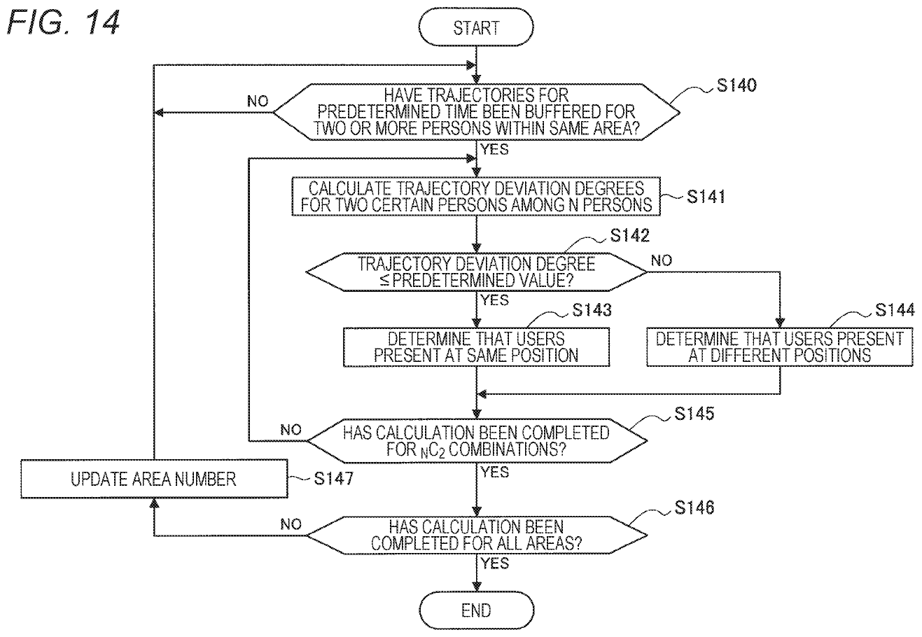

The positional sameness determination processing (S40) in FIG. 10 may be performed by the processing illustrated in FIG. 14, for example. FIG. 14 is a flowchart illustrating the positional sameness determination processing.

After acquisition of the relative trajectories of two or more persons in the same area for a predetermined time by the relative trajectory acquisition processing (S20) and the absolute position information acquisition processing (S30) in FIG. 10, the server 200 is allowed to execute the positional sameness determination processing (S140). After the positional sameness determination processing is allowed to be executed, the positional sameness determination processing may be executed at a predetermined timing.

The present embodiment determines the similarity in relative trajectories obtained by using the detection value of the inertial sensor independent of the environment, thereby determining that the users are present at a same position. Here, the relative trajectories obtained by the devices 100 of individual users might have different scales of the relative trajectory or the entire orientation of the trajectory, and thus cannot be compared in original states, in some cases. As for the scale, an error occurs due to an error in the stride of the user, and there is usually an error of about 5%. As for orientation, since the orientation of the relative trajectory is a relative orientation, there is no match in absolute orientation in typical cases. Furthermore, in a case where the acquisition time of the relative trajectory is too short, information obtained is often not enough to determine the similarity. Therefore, it is necessary to obtain the relative trajectory over a certain length of time. Moreover, defining similar trajectories obtained in completely different locations as the trajectories obtained at the same position would lead to incorrect positional sameness determination. Accordingly, the present embodiment performs the positional sameness determination by handling the relative trajectory as follows so as to be able to perform comparison of relative trajectories with high accuracy.

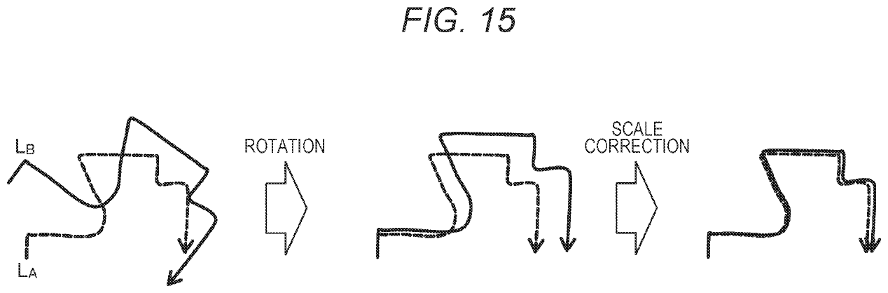

First, the scale of the relative trajectory or the deviation of the orientation of the entire trajectory is to be handled by scale correction and rotation of the trajectory. For example, as in the left illustration of FIG. 15, here is an exemplary case of determining the similarity between two relative trajectories L_{A} and L_{B} with different scales and orientations. At this time, execution of geometric fitting, that is, rotating the trajectories with their start points of the trajectories aligned with each other so as to align the orientation (center of FIG. 15), and then, overlapping the scale of one trajectory onto the other (right illustration of FIG. 15) would make it possible to bring the two relative trajectories L_{A} and L_{B} into comparable states.

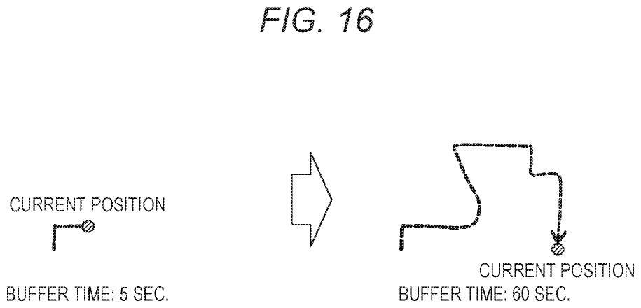

Furthermore, in order to enhance the accuracy of the positional sameness determination, it takes some time to obtain the relative trajectory as described above. For example, as in the left illustration of FIG. 16, in a case where the buffer time of the relative trajectory is short (for example, five seconds), the trajectory would also be short. This would increase probability of obtaining a similar trajectory at a different location, leading to degradation of accuracy of positional sameness determination. In order to distinguish one trajectory from another trajectory in other locations, a buffer time of a relative trajectory of a certain length (for example, 60 seconds) would be necessary as in the right illustration of FIG. 16. The longer the buffer time, the higher the accuracy of the positional sameness determination. On the other hand, extending the time to obtain the relative trajectory to enhance the accuracy of the positional sameness determination processing would cause delay in the execution of the positional sameness determination processing. Fortunately, however, since it is also possible to make realtime determination by restricting the determination target of the positional sameness determination, for example, and since the same position determination for the purpose of data mining has no severe time restriction, occurrence of determination delay of about several days would cause no problem. In this manner, ensuring a certain length of acquisition time of the relative trajectory would generate substantially no problem of delay in the positional sameness determination processing.

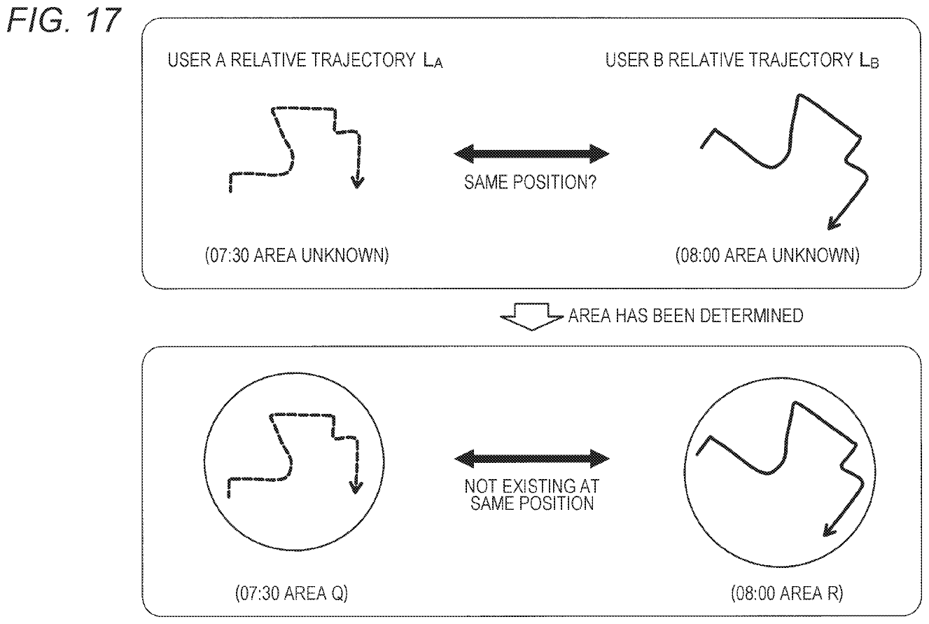

Furthermore, erroneous determination in a case where a similar trajectory is obtained in another location can be managed by using area information, for example. For example, as in the upper illustration of FIG. 17, here is an exemplary case where the relative trajectory L_{A} of a user A and the relative trajectory L_{B} of a user B are obtained and the relative trajectories L_{A} and L_{B} are similar. When focusing on the similarity of relative trajectory shapes alone, there is highly possible that it is determined that the user A and the user B existed at the same position. Therefore, determining whether or not the approximate areas in which the relative trajectories L_{A} and L_{B} are obtained are the same area would make it possible to prevent execution of the positional sameness determination for the relative trajectories obtained in completely different areas. As described above, it is sufficient to be able to perform this area determination in an approximate area such as a range of about several tens of meters, and such information can be easily identified by absolute position information obtained by the absolute position information acquisition unit 130 of the device 100. In particular, there are sufficient number of Wi-Fi access points in urban areas, and Wi-Fi positioning information can be easily obtained. In the example of FIG. 17, for example, when it is identified that the relative trajectory L_{A} of the user A has been obtained in an area Q and that the relative trajectory L_{B} of the user B has been obtained in an area R, the trajectories are not located at the same position, and thus, excluded from the target of the positional sameness determination.

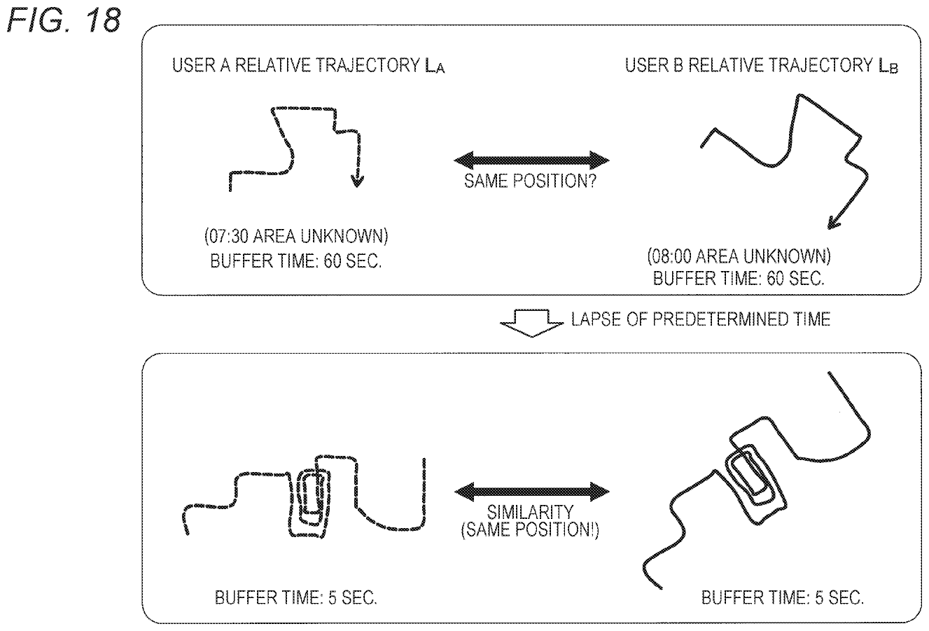

Alternatively, it is allowable to suppress occurrence of erroneous determination in a case where a similar trajectory is obtained at another location by extending the time for obtaining the relative trajectory. For example, as in the upper illustration of FIG. 18, similarly to FIG. 17, here is an exemplary case where the relative trajectory L_{A} of a user A and the relative trajectory L_{B} of a user B are obtained and the relative trajectories L_{A} and L_{B} are similar. At this time, extending the buffer time of the relative trajectory would enhance the accuracy of the positional sameness determination. Therefore, when it is determined that the relative trajectories are similar even with the extended buffer time, it is possible to determine with high accuracy that the trajectories are at the same position. For example, the buffer time of each of the relative trajectories L_{A} and L_{B} having been set to 60 seconds in the upper illustration of FIG. 18 is assumed to be extended to five minutes as in the lower illustration of FIG. 18. In a case where the relative trajectories L_{A} and L_{B} are determined to be similar even with the buffer time of five minutes, the user A and the user B can be determined to have been present at the same position with high accuracy.

Step S140 of FIG. 14 takes these into consideration and restricts the positional sameness determination target to the relative trajectories obtained in the same area by the area determination and to the relative trajectories taken with a predetermined buffer time (or more). With this configuration, it is possible to enhance the accuracy of the positional sameness determination processing.

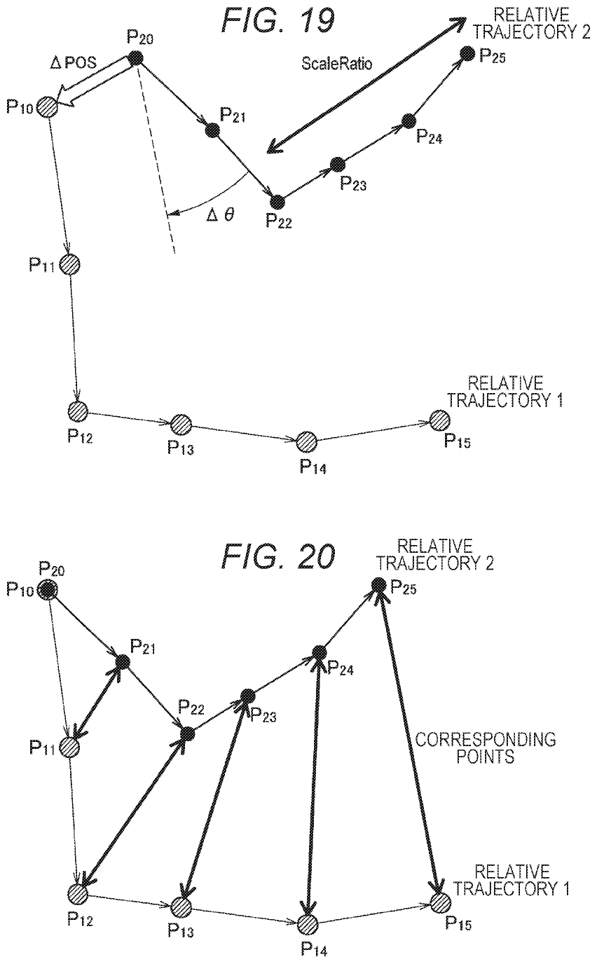

When it is allowed to execute the positional sameness determination processing in step S140, the positional sameness determination unit 220 calculates a trajectory deviation degree with respect to the relative trajectories of arbitrary two of N users as targets of the positional sameness determination (S141). The trajectory deviation degree is an index of the similarity of the relative trajectory of the positional sameness determination target. Hereinafter, an example of a method of calculating the trajectory deviation degree will be described with reference to FIGS. 19 to 27.

As illustrated in FIG. 19, there are a relative trajectory 1 and a relative trajectory 2 as the relative trajectories of the positional sameness determination target. In this example, each of the relative trajectories is defined by relative position and relative orientation at six times. In order to simplify the explanation, a relative trajectory including six relative positions is used as an example. However, in order to enhance the accuracy of the positional sameness determination, there are relative trajectories identified by about 100 relative positions, for example, used for comparison in practice. Furthermore, the relative position and relative orientation of each of users is supposed to be obtained at a same sampling interval. The trajectory deviation degree is calculated after execution of data synchronization (ΔPOS), orientation correction (Δθ), and scale correction (ScaleRatio) of the relative trajectories.

First, the positional sameness determination unit 220 performs data synchronization of the relative trajectory in which relative positions of the individual relative trajectories are associated with each other. As illustrated in FIG. 20, association of the relative positions of the individual relative trajectories are performed by using relative positions P₁₀ and P₂₀ corresponding to the start points of the relative trajectories as reference positions so as to associate other relative positions P₁₁ to P₁₅ with P₂₁ to P₂₅ on the basis of the time of acquisition of each of the positions. The corresponding relative position is also called a corresponding point. The relative positions having a same time or a closest time in each of the relative trajectories may be defined as corresponding points. In the case of the positional sameness determination at different times, it is allowable to offset the time of individual relative positions of either one of the relative trajectories by a predetermined time length, for example, and thereafter the relative positions having the same time or the closest time in individual relative trajectories may be set as corresponding points.

Note that the relative trajectories of the positional sameness determination target are supposed to have been synchronized so as to be comparable with each other. For example, data synchronization of the relative trajectory can be performed onto time-series data obtained as the detection value of the sensor unit 110 of each of the devices 100 on the basis of the time-series correlation in the following process.

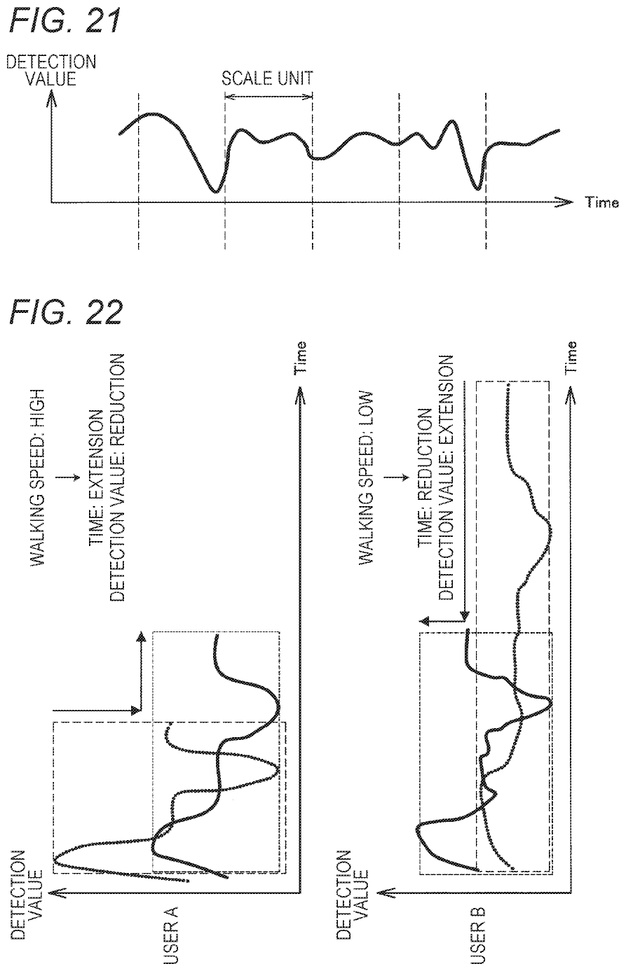

For example, here is an exemplary case where the time-series data of the detection value of the gyro sensor 113 as illustrated in FIG. 21 has been obtained as the detection value of the sensor unit 110 of the device 100. First, time-series data is segmented for each of periods to be the unit of the scale normalization of the relative trajectory (hereinafter also referred to as “scale unit”). The scale unit may be set to about 100 seconds, for example. Next, a waveform of the time-series data of the detection value segmented on a scale unit basis is normalized. Normalizing the waveform makes it possible to determine the similarity of relative trajectories on a same scale. The normalization of the waveform may be performed by changing the scale ratio of a time axis and a detection value axis on the basis of the following relationship so that the time integral value of the waveform is constant before and after normalization for each of waveforms of the scale unit.

Scale ratio (time axis)=period average speed of user/prescribed speed

Scale ratio (detection value axis)=1/scale ratio (time axis)

For example, here is an example of time-series data of detection values obtained by the gyro sensor 113 of each of the devices 100 of the users A and B as illustrated in FIG. 22. The time-series data indicated by the dotted line illustrates a part (original waveform) of the waveform of the time-series data of the detection values segmented on a scale unit basis. In the example of FIG. 22, since the walking speed of the user A is fast, the original waveform of the user A is short in a time axis direction and long in a detection value axis direction. In contrast, since the walking speed of the user B is slow, the original waveform of the user B is long in the time axis direction and short in the detection value axis direction. With execution of normalization of the original waveform with respect to the time axis and the detection value axis, the original waveform of the user A would be extended in the time axis direction and reduced in the detection value axis direction, while the original waveform of the user B would be reduced in the time axis direction and extended in the detection value axis direction, so that the waveforms be individually converted into waveforms indicated by solid lines.

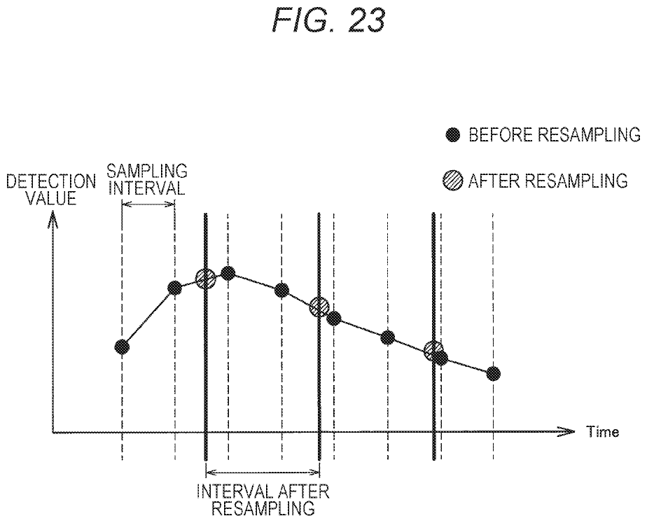

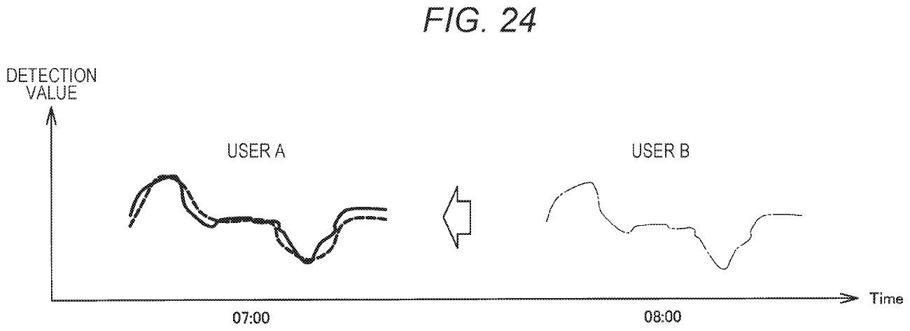

Here, normalizing the time axis changes the sampling intervals that used to be the same, and thus, resampling is performed with sampling intervals of preliminarily set prescribed interval. Resampling may be performed using linear interpolation or the like. For example, in a case where the original waveform is extended in the time axis direction as in the user A in FIG. 22, the prescribed interval after resampling becomes longer than the sampling interval used for acquisition of the original waveform value, and a detection value at this prescribed interval is to be set by linear interpolation or the like, as illustrated in FIG. 23.

Thereafter, time shift correction of correcting deviation of the absolute time length of each of the relative trajectories is performed. For example, as illustrated in FIG. 24, here is an exemplary case where the time of acquisition of the time-series data of the detection value of the user A is 7:00 and the time of acquisition of the time-series data of the detection value of the user B is 8:00. At this time, acquisition time of the detection value of either one of the users is defined as a reference and the time-series data of the detection value of the other user is shifted by a predetermined time length. The time-series data shifting time (shift amount) may be determined by searching for a value that minimizes a waveform deviation degree represented by the following expression, for example. At this time, in order to narrow down the search range, for example, it is allowable to set detection values observed at times of presence in the same area as a search target.

Waveform deviation degree=Σ((sensor detection value_{user A})−(sensor detection value_{user B}))²/m

where, m: number of detection values included in the scale unit after resampling

Note that the minimum value of the waveform deviation degree is a small value in a case where the user A and the user B exist at the same position, whereas the value is large in a case where the user A and the user B exist at different positions. That is, it is also possible to perform the positional sameness determination on users on the basis of the waveform deviation degree.

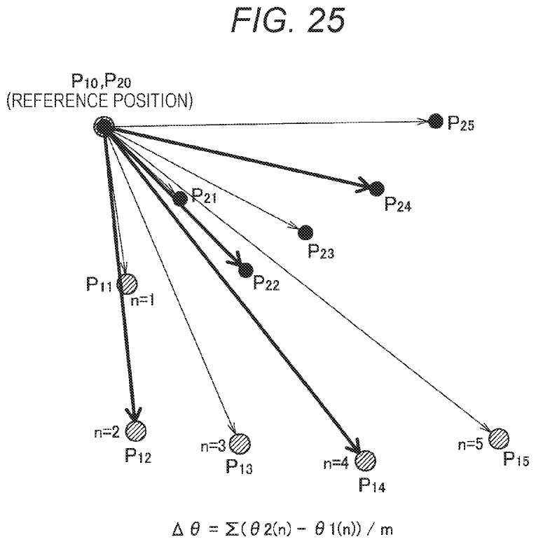

After the data synchronization of the relative trajectory is performed by this processing, the relative positions of the relative trajectories are associated with each other, and correspondence relationships of the relative positions as illustrated in FIG. 20 are obtained, for example. Next, orientation correction of the relative trajectory is performed. In the orientation correction, orientation angles θ1(n) and θ2(n) of the relative positions P₁₁ to P₁₅ and P₂₁ to P₂₅ viewed from the reference positions P₁₀ and P₂₀ are first calculated. n is a value assigned in the order of acquisition of each of relative positions with the reference position set to 0. In each of relative trajectories, the relative positions having same n are in the relationship of corresponding points. For example, as illustrated in FIG. 25, the orientation angle of the relative position P₁₁ viewed from the reference position P₁₀ is θ1(1). Thereafter, a difference sum average value of the orientation angles θ1(n) and θ2(n) of the individual relative positions is calculated and set as an orientation correction amount Δθ. That is, the orientation correction amount θΔ is expressed by the following formula.

Δθ=Σ(θ2(n)−θ1(n))/m

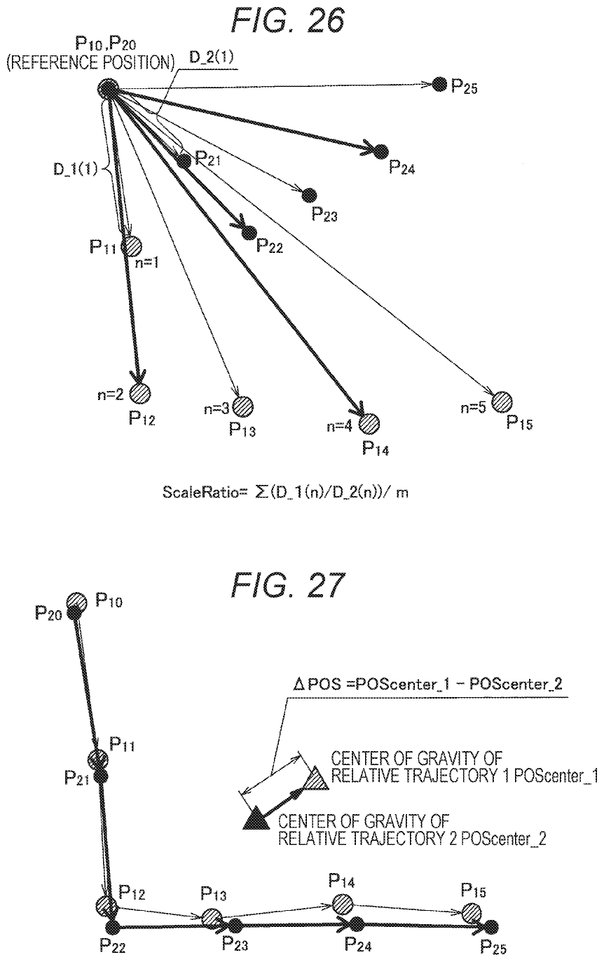

After the orientation correction is performed, scale correction of the relative trajectory is performed next. In the scale correction, distances D_1(n) and D_1(2) between the reference position and each of the relative positions are first calculated. For example, as illustrated in FIG. 26, the distance between the reference position P₁₀ and the relative position P₁₁ is D_1(1), while the distance between the reference position P₂₀ and the relative position P₂₁ is D_2(1). Thereafter, an average value of the values obtained by adding the ratios of the corresponding points of the respective relative trajectories is set as a scale correction value ScaleRatio. The scale correction value ScaleRatio is expressed by the following formula.

ScaleRatio=Σ(D_1(n)/D_2(n))/m

After performing orientation correction and scale correction, the positional sameness determination unit 220 corrects the position of the relative trajectory. Although the positions of the start point (time 0) of the relative trajectory are already aligned, the average position of the entire trajectories might be misaligned in some cases by this alignment alone. Therefore, the center of gravity of the relative trajectory is calculated from the relative position of each of the relative trajectories 1 and 2. Next, the difference of the center of gravities is defined as a position correction amount ΔPOS of the relative trajectory, and then, either one of the relative trajectories is entirely shifted by the position correction amount ΔPOS. The center of gravity of the relative trajectory may be represented by an average value of individual relative positions included in the relative trajectory. For example, as illustrated in FIG. 27, when the center of gravity of the relative trajectory 1 is POS_{center-1} and the center of gravity of the relative trajectory 2 is POS_{center-2}, the difference between these centers of gravity would be the position correction value ΔPOS. Thereafter, by shifting either one of the relative trajectories (for example, relative trajectory 2) to the other (relative trajectory 1) side, position correction of the relative trajectory is performed.

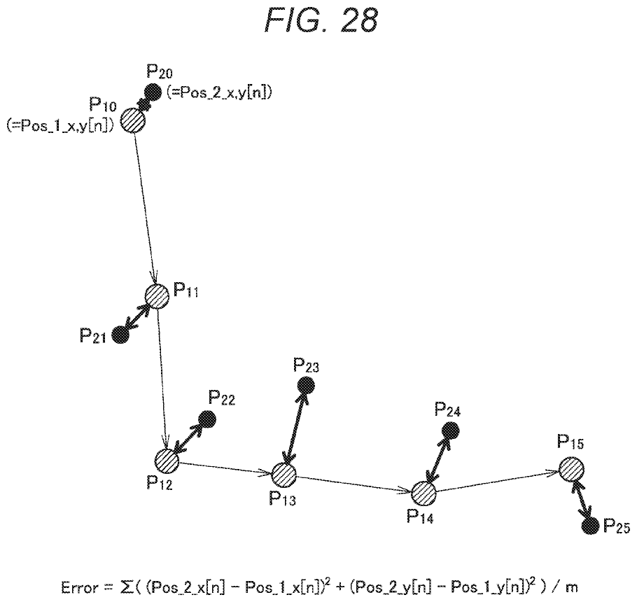

As described above, performing data synchronization (ΔPOS), orientation correction (Δθ), and scale correction (ScaleRatio) on the relative trajectory minimizes the distance difference between the relative trajectories. In this state, as illustrated in FIG. 28, the root mean square of the distance between the corresponding points of individual relative trajectories is calculated, and the average value is defined as the trajectory deviation degree of the relative trajectory. That is, in the present embodiment, the trajectory deviation degree is calculated by the least squared error, and the trajectory deviation degree Error is expressed by the following formula.

Error=Σ((Pos_2_x[n]−Pos_1_x[n])²+(Pos_2_y[n]−Pos_1_y[n])²)/m

Returning to the explanation of FIG. 14. The trajectory deviation degree is calculated in step 141, and then, the positional sameness determination unit 220 determines whether or not the trajectory deviation degree is a predetermined value or less (S142). In a case where it is determined in step S142 that the trajectory deviation degree is the predetermined value or less, it is determined that the users exist at a same position (S143). In contrast, in a case where it is determined in step S142 that the trajectory deviation degree is larger than the predetermined value, it is determined that the users do not exist at the same position (S144). Subsequently, in a case where the positional sameness determination for the current two users is completed, the positional sameness determination unit 220 confirms whether or not the positional sameness determination processing has been completed for all combinations of all users who are the positional sameness determination targets (S145). In a case where there is a combination of users for which determination has not been completed, the processing from step S141 is repeated.

In contrast, in a case where the positional sameness determination is completed for all user combinations, the positional sameness determination unit 220 confirms whether or not the positional sameness determination processing is executable in other areas (S146). When there is an area for which determination has not been completed, the area number set for each of areas is updated (S147), and execution of processing from step S140 is repeated. Thereafter, when there is no more information for which the positional sameness determination processing is to be implemented, the positional sameness determination unit 220 finishes the processing illustrated in FIG. 14. The positional sameness determination processing according to the present embodiment has been described above.

(1.4. Social Attribute Identification Processing)

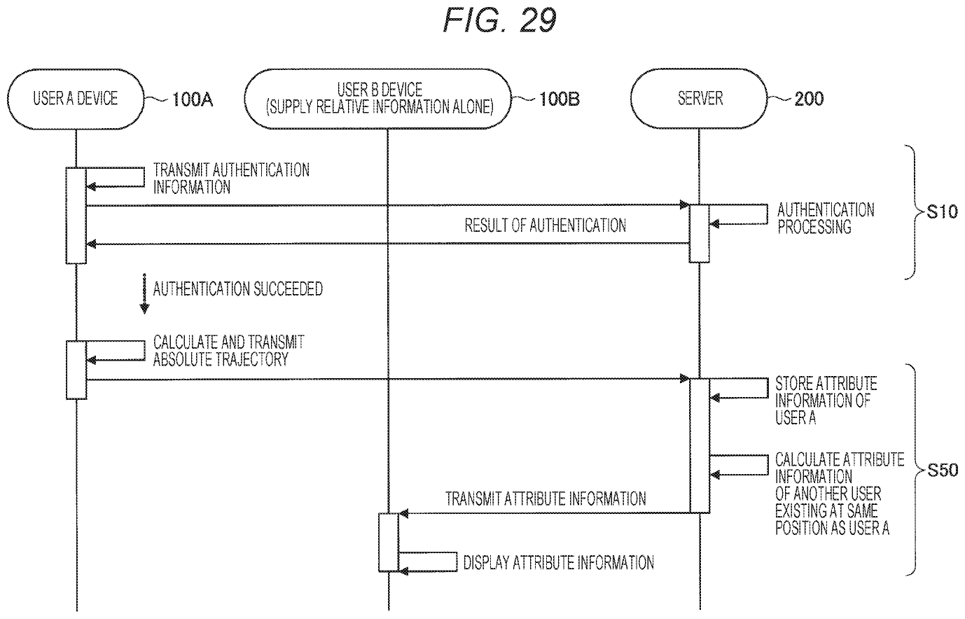

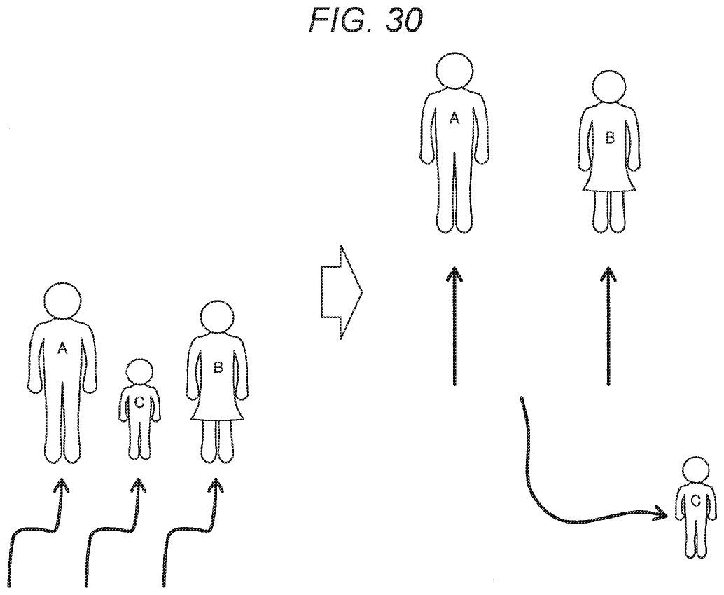

Social attribute identification processing of identifying social attributes of a plurality of users determined to have some relevance in the positional sameness determination processing will be described with reference to FIG. 29. FIG. 29 is a sequence diagram illustrating a processing flow of the information processing system 1 at execution of social attribute identification processing for a plurality of users. Here is an exemplary case where it is determined that there is some relevance between the user A and the user B and identification of the social attribute of the user A led to identification of the social attribute of the user B.

The social attribute identification processing is started from user authentication processing by the device communicating with the server 200 (S10). For example, authentication information is transmitted from a device 100A of the user A to the server 200, the server 200 executes authentication processing on the basis of the authentication information and transmits an authentication result to the device 100A. Although FIG. 29 describes simply authentication processing of the user A, authentication processing is similarly executed for user B as well. In a case where the user is authenticated, the processing of step S50 is executed on the device 100A, the device of the user B, and the server 200.

Here it is assumed that, after the authentication information is authenticated, the device 100A of the user A has obtained absolute position information by the absolute position information acquisition unit 130 and the absolute trajectory of the user A has been obtained. The absolute trajectory is output to the server 200 via the transmission unit 160. The server 200 having received the absolute trajectory records the information in the obtained data storage unit 250. Furthermore, the attribute identification unit 230 identifies the social attribute of the user B, having relevance to the user A, on the basis of the absolute trajectory of the user A. For example, as illustrated in FIG. 4, it is assumed that there is a known relevance that the user A and the user B move through “a certain common route”. At this time, the attribute identification unit 230 identifies the absolute position of the common route on the basis of the absolute trajectory obtained for the user A. Furthermore, in a case where there is information regarding other routes connected to the common route for the user B, the attribute identification unit 230 may also identify the absolute position of those routes. In this manner, the attribute identification unit 230 identifies the social attribute of the user B whose relative information alone has been supplied.

Thereafter, the server 200 may transmit a result of the social attribute identification processing to the device 100B of the user B as necessary. The device 100B that has received the result of the social attribute identification processing may display the determination result on the display unit, for example, and notify the user of the result.

The above has described the information processing system 1 according to the first embodiment and the positional sameness determination processing of a plurality of users by this information processing system 1 and the social attribute identification processing of identifying social attributes of the users determined to have some relevance by the positional sameness determination processing. According to the present disclosure, the positional sameness determination processing is performed on the basis of a relative trajectory obtained on the basis of an inertial sensor independent of the environment. This enables implementation of the positional sameness determination with high accuracy without depending on the environment. Furthermore, the detection value used for the positional sameness determination can be easily obtained from a sensor mounted on a general-purpose device. Moreover, regarding the social attributes of the plurality of users determined to have some relevance by the positional sameness determination processing, it is possible to identify the social attributes of other users from identified social attributes of a certain user, making it possible to easily identify the absolute value of the user's social attribute.

### 2. Second Embodiment

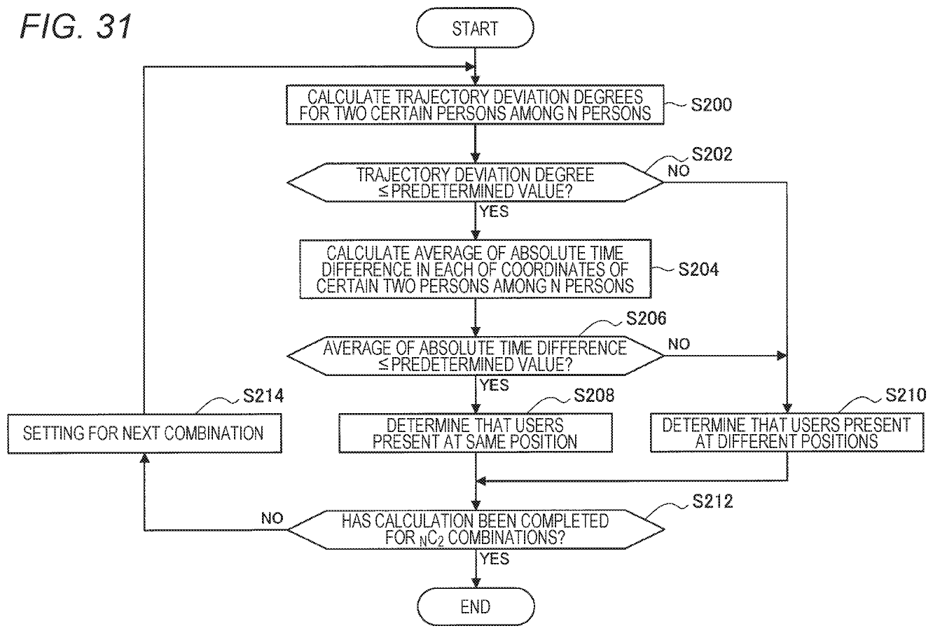

Next, a second embodiment of the present disclosure will be described with reference to FIGS. 30 and 31. The present embodiment is a case where the positional sameness determination processing target devices are limited and the positional sameness determination is performed in real time. Since the system configuration and processing details of the present embodiment are basically the same as those of the first embodiment, a detailed description thereof will be omitted.

In the positional sameness determination in real time, as illustrated in FIG. 30, for example, the number of positional sameness determination targets is limited to a small number, such as a family of father A, mother B, and child C. In a case where the father A, the mother B, and the child C are at the same position as in the left illustration of FIG. 30, the movement trajectories of all the members are similar. However, as in the right illustration of FIG. 30, there is a case where the movement trajectory of the child C is different from the movement trajectories of the father A and the mother B, and at this time, it is possible to identify a fact that the child C has strayed from the father A and the mother B. In such a case, it is necessary to perform positional sameness determination in real time. Additionally, limiting the number of the positional sameness determination targets to a small number would make it possible to ensure realtime property of processing.

Specifically, the positional sameness determination processing is performed in real time by the processing as illustrated in FIG. 31. The positional sameness determination in real time is periodically repeated at a predetermined determination timing. The positional sameness determination processing illustrated in FIG. 31 represents processing executed at one determination timing, and the same determination processing is supposed to be executed every determination timing.

First, the positional sameness determination unit 220 calculates a trajectory deviation degree with respect to the relative trajectories of arbitrary two of N users as targets of the positional sameness determination (S200). As described in the first embodiment, the trajectory deviation degree is an index of the similarity of the relative trajectories of the positional sameness determination targets and is represented by the least squared error of individual relative positions of the relative trajectories to be compared, for example. The positional sameness determination unit 220 determines whether or not the trajectory deviation degree is a predetermined value or less (S202). In a case where it is determined in step S202 that the deviation degree of the trajectory is larger than the predetermined value, it is determined that the users exist at different positions (S210).

In contrast, in a case where it is determined in step S202 that the trajectory deviation degree is the predetermined value or less, the difference average value of the absolute times of the respective relative positions with respect to the two users is calculated (S204). In the present embodiment, it is important to be present at a same position at a same time. Therefore, it is determined that similar trajectories are obtained at a same timing on the basis of a difference average value of the absolute time. In step S206, in a case where the difference average value of the absolute time is a predetermined time or less, it is determined that the two users exist at the same position at the same time (S208). In contrast, in a case where it is determined in step S206 that the difference average value of the absolute time is larger than the predetermined time, it is determined that the users exist at different positions (S210).

Subsequently, when the positional sameness determination for the current two users is completed, the positional sameness determination unit 220 confirms whether or not the positional sameness determination processing has been completed for all combinations of all users who are the positional sameness determination targets (S212). In a case where there is a combination of users for which determination has not been completed, next combination will be set (S214), and the processing from step S200 is repeated. In a case where the positional sameness determination is completed for all user combinations, the positional sameness determination unit 220 finishes the processing illustrated in FIG. 31.

The above has described the positional sameness determination processing in real time according to the present embodiment. The positional sameness determination processing in real time makes it possible to learn whether or not a plurality of users exists at the same place. Note that, in view of the idea that it is desirable to enable early identification of the child straying from the parent in parent-child positional sameness determination processing in FIG. 30, the buffer time of the relative trajectory used for determination may be set to be shorter (for example, about 10 seconds). In contrast, in a case where the degree of urgency is low, such as in a case where it is desired to determine that a separated user has joined, the buffer time of the relative trajectory used for the determination in FIG. 31 may be set longer (for example, about 30 seconds). In this manner, the buffer time of the relative trajectory used for determination may be varied in accordance with the details of the positional sameness determination.

### 3. Third Embodiment

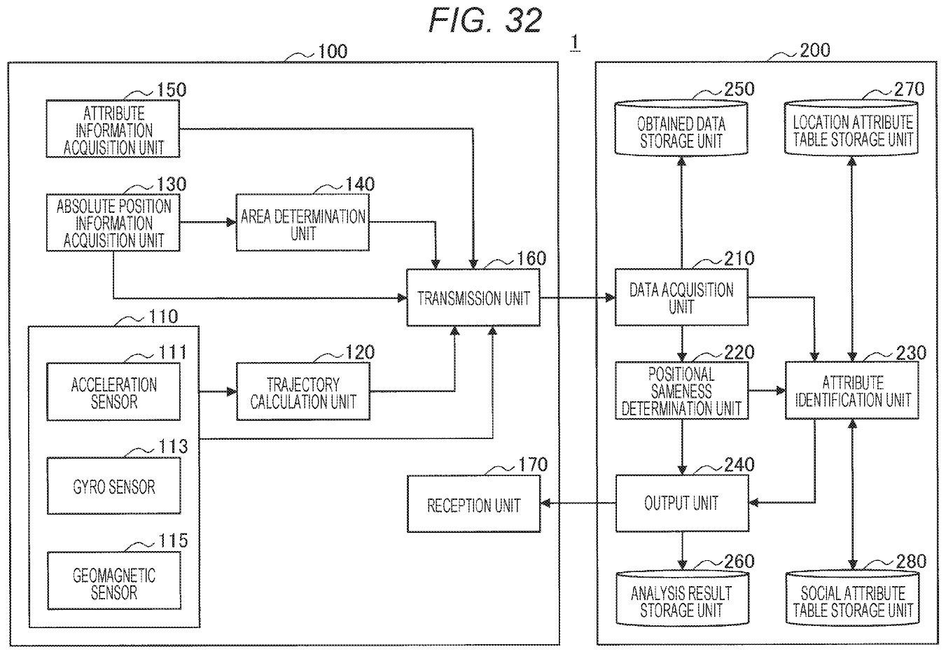

Next, a third embodiment of the present disclosure will be described with reference to FIGS. 32 to 40. The present embodiment uses information regarding staying time at a position of the users determined to exist at the same position by the positional sameness determination processing and identifies behavior of the user. This identification uses a location attribute table setting information regarding the staying time on the basis of user behavior tendency. The location attribute table can be used to identify the staying position of the user without need to measure the position with high accuracy. Hereinafter, user behavior identification processing performed by the information processing system according to the present embodiment will be described. Note that a detailed description of the system configuration and processing details of the present embodiment that is same as in the first embodiment will be omitted.

<3.1. Configuration of Information Processing System>

FIG. 32 illustrates a configuration example of the information processing system 1 according to the present embodiment. FIG. 32 is a functional block diagram illustrating a configuration of the information processing system 1 according to the present embodiment.

As illustrated in FIG. 32, the information processing system 1 according to the present embodiment includes: a device 100 held by a user; and a server 200 that executes positional sameness determination processing and attribute identification processing on the basis of information obtained by the device 100. Similarly to the first embodiment, although FIG. 32 includes one device 100, the device 100 held by each of a plurality of users is connected to the server 200. The server 200 executes positional sameness determination processing and attribute identification processing on the basis of data received from a plurality of devices 100.

(1) Device

The device 100 is an information processing terminal held by a user, such as a smartphone and a wearable terminal. As illustrated in FIG. 32, the device 100 includes a sensor unit 110, a trajectory calculation unit 120, an absolute position information acquisition unit 130, an area determination unit 140, an attribute information acquisition unit 150, a transmission unit 160, and a reception unit 170. Since the device 100 illustrated in FIG. 32 has the same configuration and the same function as those of the first embodiment, explanation will be omitted here.

(2) Server

The server 200 performs positional sameness determination of determining whether or not users exist (existed) at a same position on the basis of information input from the device 100 of each of the users. Furthermore, the server 200 according to the present embodiment executes the processing of identifying behavior of users determined to exist at same position by the positional sameness determination processing. The server 200 may also be capable of executing social attribute identification processing of identifying social attributes of the user. As illustrated in FIG. 32, the server 200 includes a data acquisition unit 210, a positional sameness determination unit 220, an attribute identification unit 230, an output unit 240, an obtained data storage unit 250, an analysis result storage unit 260, a location attribute table storage unit 270, and a social attribute table storage unit 280.

The data acquisition unit 210 receives various types of information from a plurality of the devices 100 that can communicate with the server 200. The data acquisition unit 210 obtains detection values of individual sensors of the sensor unit 110, a relative trajectory of a user calculated by the trajectory calculation unit 120, absolute position information obtained by the absolute position information acquisition unit 130, and area information identified by the area determination unit 140. These pieces of information are used for positional sameness determination processing and are output to the positional sameness determination unit 220. Furthermore, the data acquisition unit 210 can also obtain the social attribute of the user, or information that can be used to identify the social attribute, obtained by the attribute information acquisition unit 150. Such information is output to the attribute identification unit 230. Furthermore, the data acquisition unit 210 may record the obtained various types of information in the obtained data storage unit 250.

The positional sameness determination unit 220 determines users existing at a same position. The positional sameness determination unit 220 according to the present embodiment determines the similarity of the relative trajectory of each of users and determines whether or not the users exist at a same position. The positional sameness determination unit 220 may function as a functioning unit that implements functions of: a synchronization processing unit that performs data synchronization of the positional sameness determination target; a deviation degree calculation unit that calculates a degree of deviation of the synchronized time-series data; and a determination processing unit that performs positional sameness determination of the users on the basis of calculated deviation degree. Note that the positional sameness determination processing by the positional sameness determination unit 220 is the same as that in the first embodiment, and thus, description thereof will be omitted here. The positional sameness determination unit 220 outputs the determination result to the output unit 240. The positional sameness determination unit 220 may output a determination result to the attribute identification unit 230.

The attribute identification unit 230 identifies behavior of the users determined to have some relevance by their presence at a same position by the positional sameness determination processing. In the present embodiment, the attribute identification unit 230 calculates location attribute information including information regarding the staying time at the location where these users stay. Thereafter, the attribute identification unit 230 identifies the behavior of the user on the basis of the calculated location attribute information and the location attribute table recorded in the location attribute table storage unit 270 described later. Furthermore, the attribute identification unit 230 may identify the social attribute of the user on the basis of the social attribute table recorded in the social attribute table storage unit 280 described later.

Furthermore, similarly to the first embodiment, the attribute identification unit 230 can identify behavior of all users having relevance on the basis of the behavior details or information that can be used to identify the behavior, obtained for at least one user. In a similar manner, the attribute identification unit 230 can identify social attributes of all users having relevance on the basis of the social attribute or information that can be used to identify the social attribute, obtained for at least one user. The attribute identification unit 230 can also update the location attribute table or update the social attribute table on the basis of the information obtained from the user. The attribute identification unit 230 may output the identified user's behavior or social attribute to the output unit 240.

The output unit 240 transmits information to the device 100 connected to the server 200. For example, the output unit 240 may output a result of determination by the positional sameness determination unit 220 and the user's behavior or social attribute identified by the attribute identification unit 230, to the device 100 of the user as a notification target. Furthermore, the output unit 240 may record the processing result of the server 200 in the analysis result storage unit 260.

The obtained data storage unit 250 is a storage unit that stores various pieces of information obtained from each of the devices 100. The analysis result storage unit 260 is a storage unit that stores the processing result in the server 200. The information held in these storage units can also be utilized for data mining or the like.

The location attribute table storage unit 270 stores a location attribute table in which information regarding the staying time is set in accordance with a location or behavior. The location attribute table sets, for example, a staying time in which certain behavior of a user is performed and a staying time length during which the user stays for performing the behavior, as the information regarding the staying time. For example, in the location attribute table concerning lunch, setting of the table is such that the staying time is from 12:00 to 13:00 and the staying time length is 10 to 30 minutes. The attribute identification unit 230 refers to the location attribute table storage unit 270 and identifies a location attribute tables having user's location attribute information matching each other. This makes it possible to identify the behavior at a user's staying location.

The social attribute table storage unit 280 stores a social attribute table set on the basis of the staying time and the staying time length. In a case where there are users with different staying time lengths or staying times at a same location, the social attributes of these users are considered to be different. For example, a user at a restaurant having staying time from 12:00 to 13:00 and the staying time length of 10 to 30 minutes can be estimated to be a customer who has lunch at a restaurant. In contrast, a user at a restaurant having staying time from approximately 9:00 to 15:00 and the staying time length of about six hours can be estimated to be a shop clerk of the restaurant. The social attribute table sets general information for identifying social attributes of users from their staying times and staying time lengths. The attribute identification unit 230 refers to the social attribute table storage unit 280 and identifies a social attribute tables having user's location attribute information matching each other. This makes it possible to identify the social attribute of the user.

The configuration of the information processing system 1 according to the present embodiment has been described above. Note that while the present embodiment is an example in which the positional sameness determination processing and attribute identification processing are executed by one server 200, the present disclosure is not limited to this example. The positional sameness determination processing and attribute identification processing may be configured to be executed by different servers, or at least one of the processing may be configured to be executable by the device 100.

(3.2. Behavior Identification Processing Using Location Attribute Table)

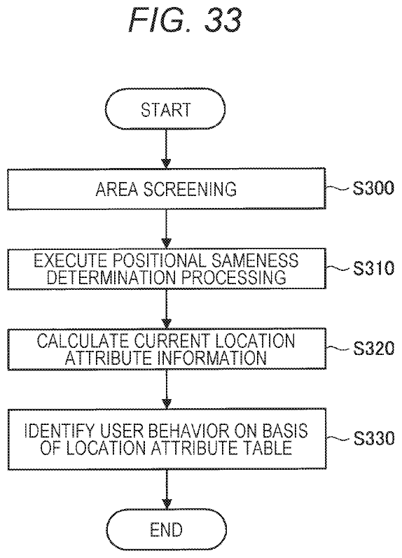

The behavior identification processing using the location attribute table according to the present embodiment will be described with reference to FIG. 33. FIG. 33 is a flowchart illustrating the behavior identification processing using the location attribute table according to the present embodiment. In the behavior identification processing using the location attribute table according to the present embodiment, comparison is performed on a plurality of users who stay (stayed) at a same position, specifically between the location attribute information and the location attribute table of the users at the location, so as to identify the behavior of the users.

(1) Area Screening

First, in order to identify the users staying at the same position, screening of the user staying area is performed (S300). By area screening, users having similar trajectories but existing in different areas are excluded so as to enhance the accuracy of the positional sameness determination processing described later. The area screening may be performed, for example, by executing the processing of step S132 in FIG. 13 by the area determination unit 140 of the device 100, similarly to the first embodiment. High determination accuracy is not required for area determination, and it is sufficient as long as an approximate position represented in the range of about several tens of meters can be identified using Wi-Fi or GPS, etc., for example. The area determination unit 140 outputs the determined area to the transmission unit 160.

(2) Positional Sameness Determination Processing

Next, among the users determined to be present in the same area by the area screening, the positional sameness determination unit 220 identifies the users existing at a same position (S310). The positional sameness determination unit 220 determines the similarity of the relative trajectory of each of users and determines whether or not the users exist at a same position. The positional sameness determination processing is implemented by using a relative trajectory corresponding to a predetermined time of the user calculated on the basis of PDR, inertial navigation calculation processing, or the like. Similarly to the first embodiment, the relative trajectory is supposed to have been calculated on the basis of the relative trajectory calculation processing illustrated in FIG. 12, for example. Similarly to the first embodiment, the positional sameness determination unit 220 compares the relative trajectories on the basis of the positional sameness determination processing illustrated in FIG. 14, for example, and determines the users present at the same position. The positional sameness determination unit 220 outputs the determination result to the output unit 240. Note that the determination result may be output to the attribute identification unit 230.

Note that when a highly accurate communication technology capable of positioning the user's absolute position information at once becomes generally available, the positional sameness determination processing may be performed on the basis of the absolute position information obtained by the communication technology, other than performed on the basis of the similarity of the relative trajectories. Furthermore, the positional sameness determination can be performed on the basis of a result of positioning by combining PDR and map matching.

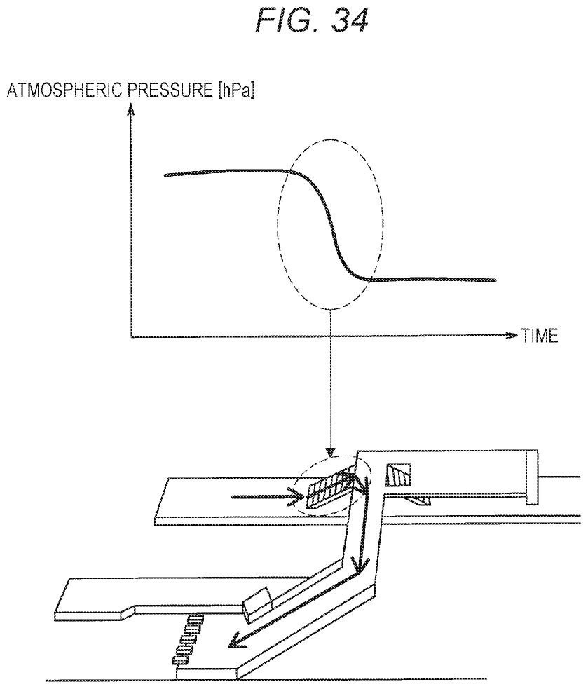

Moreover, an atmospheric pressure sensor is provided in the sensor unit 110 of the device 100 in acquisition of the relative trajectory, it is possible to estimate the altitude, enabling detection of a three-dimensional trajectory including user's movement across floors of a building. For example, as illustrated in FIG. 34, when the user moves up the stairs from the station platform to a communication passage, the pressure measured by the atmospheric pressure sensor provided in the device 100 drops. The use of the change in the measured atmospheric pressure would make it possible to obtain relative trajectory with higher accuracy, enabling enhancement of the accuracy of the positional sameness determination processing.

(3) Location Attribute Identification Processing and Behavior Identification Processing

When the users existing at a same position are identified, the attribute identification unit 230 calculates the location attribute information of the users existing at the same position (S320) and identifies behavior of the users (S330). The attribute identification unit 230 refers to the location attribute table storage unit 270, identifies the location attributes of the users on the basis of the information regarding the staying times of the users, and then, identifies the behavior of the users. In the present embodiment, information to be obtained using the location attribute table is not absolute position information of the users, but context information associated with location, such as “shopping”, “having a meal”, or “staying in a cafe”. Therefore, the location attribute table is not limited to the purpose of identifying that the user is staying at a specific location, but also is used for the purpose of identifying the user's behavior or the location where the behavior is performed.

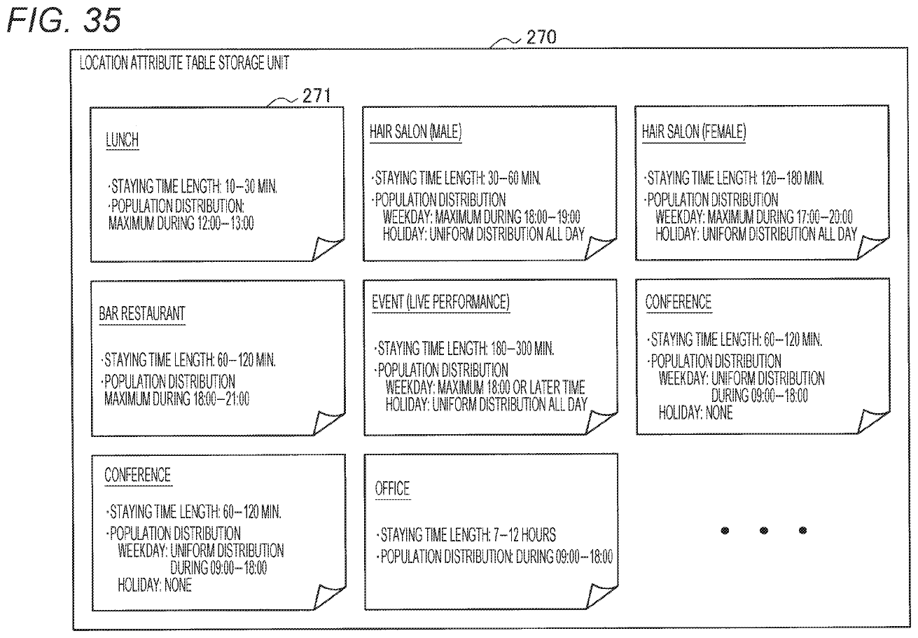

The location attribute table stored in the location attribute table storage unit 270 is set for each of location where certain behavior is performed on the basis of information based on the staying times of a plurality of users. For example, the location attribute table for identifying the fact that the user is having lunch may be set on the basis of past user behavior data, or may be set as appropriate by a system setting engineer. Specifically, as illustrated in FIG. 35, the location attribute table storage unit 270 stores one or more location attribute tables 271. The location attribute table 271 illustrated in FIG. 35 includes the setting of population distribution at the times at which the behavior is performed and the staying time length, as information based on the staying time.

For example, the location attribute table identifying a fact that the user is having lunch has a setting that the population distribution over time has a peak from 12:00 to 13:00 and the staying time length is 10 to 30 minutes. Furthermore, for example, since the tendency of the population distribution over time and the staying time length differs between male and female in the location attribute table identifying the fact that the user is in a hair salon, the location attribute table may be set for each of male/female groups. Regarding the population distribution over times, for example, in a case where there is a difference in the trend between weekdays and holidays, as indicated in a location attribute table that identifies the fact that the user is in a hair salon or in a location attribute table that identifies the fact that the user is at a conference, illustrated as FIG. 35, the population distribution over times corresponding to the day of the week may be set. The location attribute table may include, for example, the setting of the ratio of the total number of persons per day performing the behavior to the actual number of people (that is, the frequency at which the user performs the behavior) or the like, in addition to the population distribution over time and the staying time length.

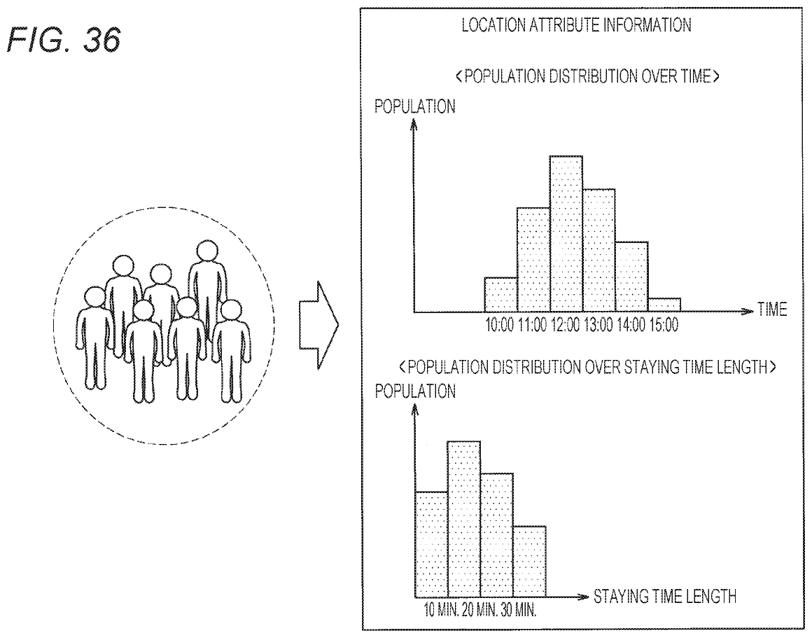

In step S320, the population distribution over time and the population distribution over staying time length on the basis of the staying times at the position of the users determined in step S310 to exist at the same position are calculated. As illustrated in FIG. 36, for example, the attribute identification unit 230 calculates the population distribution over time and the population distribution over staying time length for the plurality of users existing at the same position on the basis of time information at the position as the location attribute information of the user.

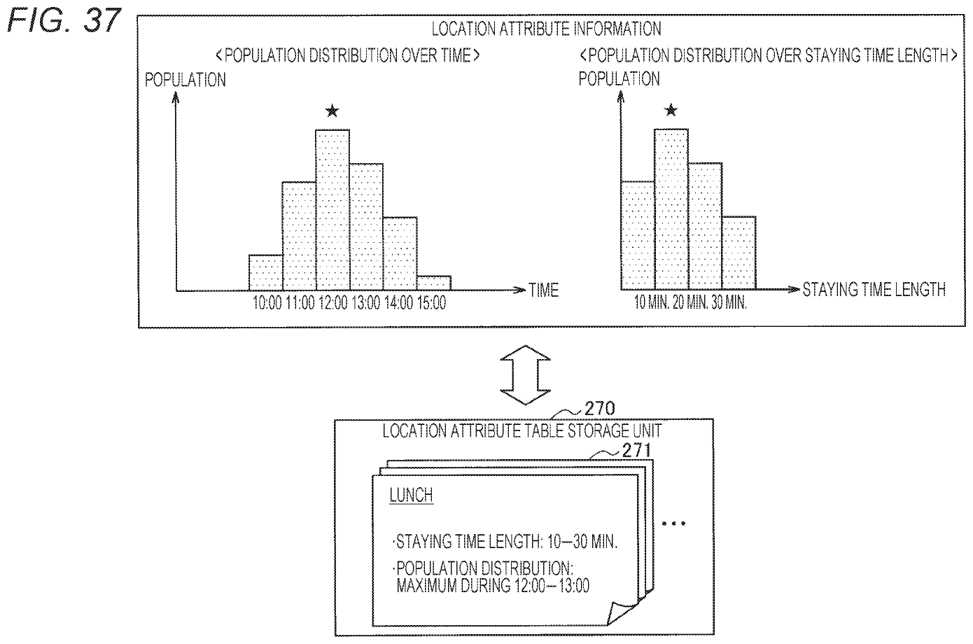

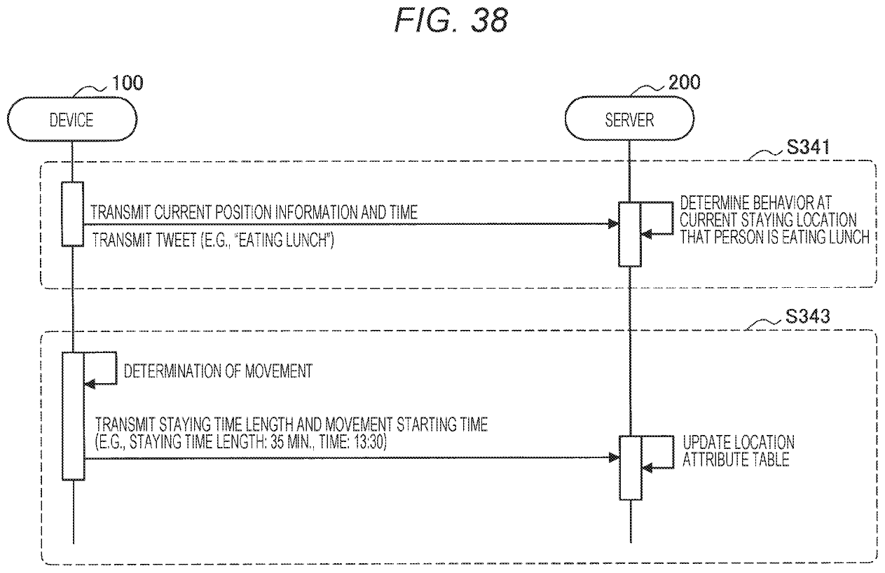

Thereafter, the attribute identification unit 230 refers to the location attribute table storage unit 270 and identifies the location attribute table 271 that matches the calculated location attribute information, and then, identifies the behavior of these users (S330). The attribute identification unit 230 may identify a peak value of the location attribute information and may perform matching with the location attribute table. For example, according to the location attribute information of the user illustrated in FIG. 37, the peak value of the population distribution over time is 12:00, and the peak value of the population distribution over staying time length is 10 minutes to 20 minutes. The attribute identification unit 230 compares the peak values with the population distribution over time and the staying time length set in the location attribute table 271. Next, when the peak value satisfies the value set in the location attribute table 271, for example, the attribute identification unit 230 determines that the users satisfy the location attribute of the location attribute table. In the example of FIG. 37, the location attribute information matches the location attribute table identifying the fact that the user is having lunch from the peak being 12:00 to 13:00 and the staying time length of 10 to 30 minutes. Accordingly, it is possible to identify the fact that these users are having lunch.

In this manner, the location attribute table 271 can be used to identify the behavior of the users existing at the same position. The attribute identification unit 230 may output the identified behavior to the output unit 240.

In step S330, the behavior of the users is identified by comparing the location attribute information of the user and the location attribute table. Alternatively, similarly to the first embodiment, for example, the behavior of the users may be identified on the basis of information revealed by one of the users existing at the same position by SNS or the like. Furthermore, the information regarding the behavior revealed by the user is more accurate than the user's behavior estimated on the basis of the location attribute table. Accordingly, the location attribute table for identifying the corresponding behavior may be updated on the basis of the information revealed by the user.

Specifically, for example, instead of steps S320 and S330 of FIG. 33, the processing of FIG. 38 may be executed to identify the behavior of the users at the same position and may update the location attribute table. That is, as illustrated in FIG. 38, here is a case where users existing at a same position are identified by the positional sameness determination, and one of the users existing at that position revealed a tweet on SNS or the like that the user is having lunch. The device 100 of the user transmits the information that the user is having lunch together with the position information and time at the current position, to the server 200 (S341). On the basis of the information received from the device 100, the server 200 determines that the current user's behavior at the position of stay is behavior of having lunch.

Thereafter, when the device 100 detects the user's start of movement from the position of stay, the device 100 transmits the movement start time at the user's location of stay to the server 200 (S343). Movement start determination processing may be performed on the basis of a detection value of the acceleration sensor 111, for example, similarly to the steps S106 and S108 in FIG. 11. After detecting the start of movement of the user, the device 100 transmits the staying time length at the location of stay and the movement starting time to the server 200. The data acquisition unit 210 of the server 200 outputs the information received from the device 100 to the attribute identification unit 230. For example, as illustrated in FIG. 38, the device 100 transmits information of the staying time length of 35 minutes and the movement starting time of 13:30 to the server 200. On the basis of the information, the attribute identification unit 230 updates the information in the location attribute table 271 that identifies the fact that the user is having lunch.

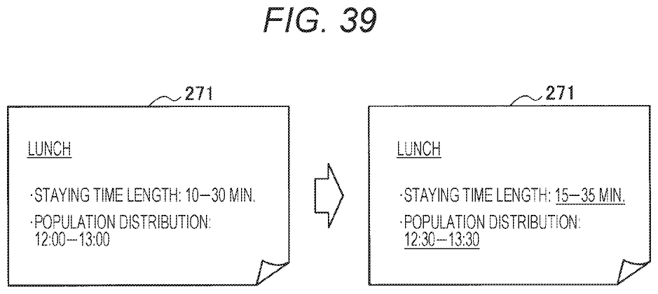

The updating of the location attribute table 271 may be performed on the basis of the information of one user. Still, updating performed on the basis of the statistical result of the information of a plurality of users would make it possible to reduce the influence of variation of behavior of users, enabling updating to the location attribute table 271 closer to the actual situation. As illustrated in FIG. 39, the attribute identification unit 230 changes the trend of the population distribution over time and the staying time length on the basis of the statistical result of the information revealed by the user as illustrated in FIG. 38, for example, and updates the location attribute table 271 accordingly.

(4) Social Attribute Determination Processing

In behavior identification processing using the location attribute table 271 illustrated in FIG. 33, the behavior of the user existing at the same position is identified from the location attribute table 271. Moreover, it is also possible to determine the social attributes of each of users from the location attribute table 271.

In a case where there is a user, for example, determined to be in a conference by the location attribute table that identifies the fact that the user is in a conference out of the location attribute tables 271 stored in the location attribute table storage unit 270 of FIG. 35, this user is estimated to be an office worker. Furthermore, as a more detailed social attribute, for example, the user with a long cumulative conference time per day can be estimated to be a senior manager.

Moreover, in another case where a user determined to be eating and drinking by a location attribute table that identifies the fact that the user is in a bar restaurant, for example, is often at a place different from the location at the time of determination of that fact that the user is eating and drinking, from the position information of the user, the eating and drinking is estimated to be a client dinner. It is also possible to determine that such a user works in a business division involving dealing with individual customers. Note that when the users are determined to be eating and drinking at the same place, it is estimated that the restaurant is their favorite place.

Alternatively, a user who is determined to be on duty, for example, by a location attribute table identifying the fact that the user is in office can be estimated to be an in-service worker such as a researcher or a receptionist, on the basis of their long staying time length in the office.

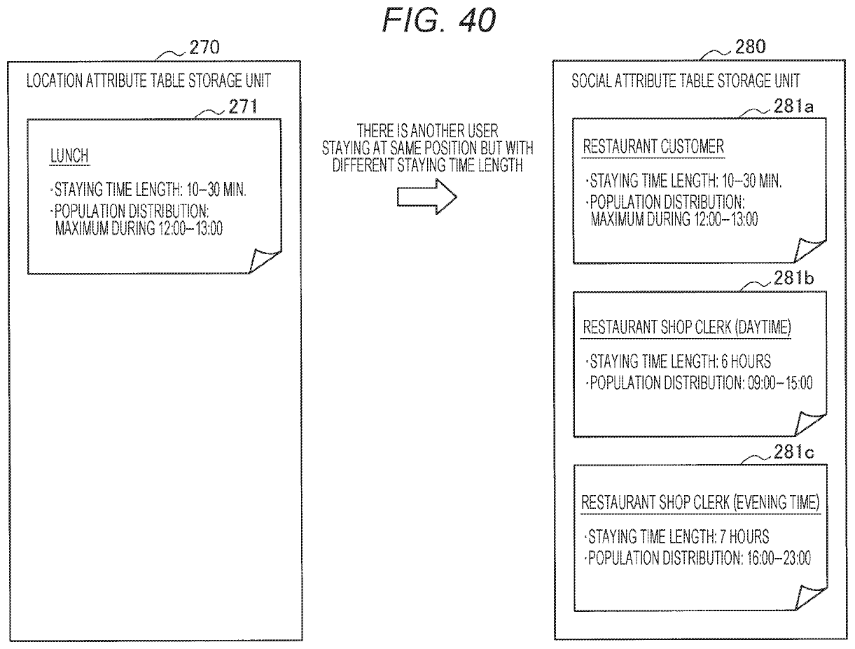

Furthermore, it is also conceivable that the users staying at the same location but having different social attributes. For example, as in the left illustration of FIG. 40, the location attribute table storage unit 270 includes a location attribute table 271 to identify the fact that the user is having lunch. Additionally, here is a case where the fact that the user is in a restaurant where users having lunch stay, from the location attribute table 271, that is, from the position information of the user when the user's behavior is identified as having lunch. Normally, the user is estimated to be a customer of a restaurant from the location attribute table 271. However, users who are located at the same position known from the positional sameness determination processing but with different staying times or staying time length are estimated to be shop clerks of the restaurant rather than customers of the restaurant.

In this manner, in a case where the users' staying times or the staying time lengths are mutually different, the social attribute of the users can be estimated. Similarly to the location attribute table, the social attribute table also includes setting of information regarding the staying times. For example, as in right illustration of FIG. 40, for the restaurant, the social attribute table storage unit 280 records a social attribute table 281a for identifying customers, a social attribute table 281b for identifying shop clerks working daytime, a social attribute table 281c for identifying a shop clerk working in the evening, and the like. With reference to the social attribute table storage unit 280, the attribute identification unit 230 can identify the user's social attribute from information based on the user's staying times.

### 4. Hardware Configuration

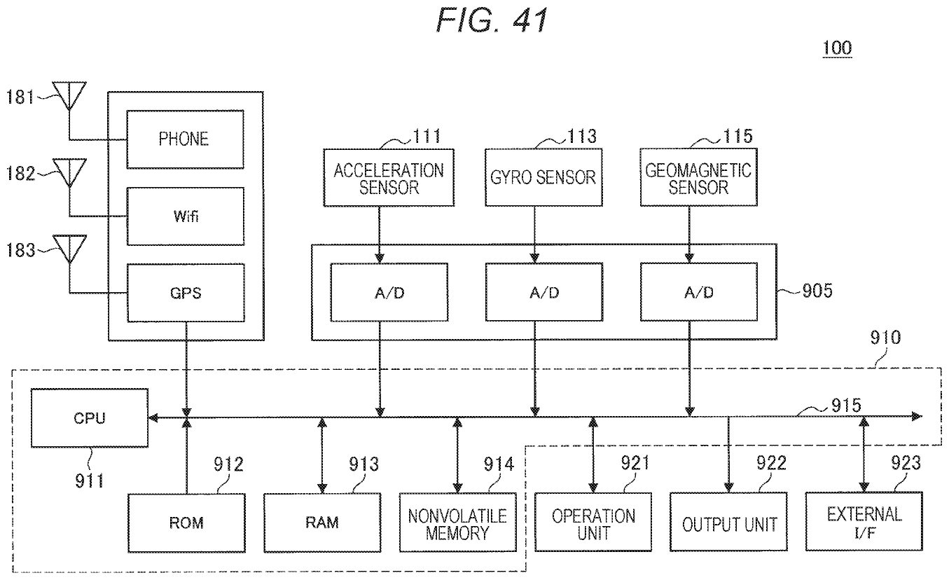

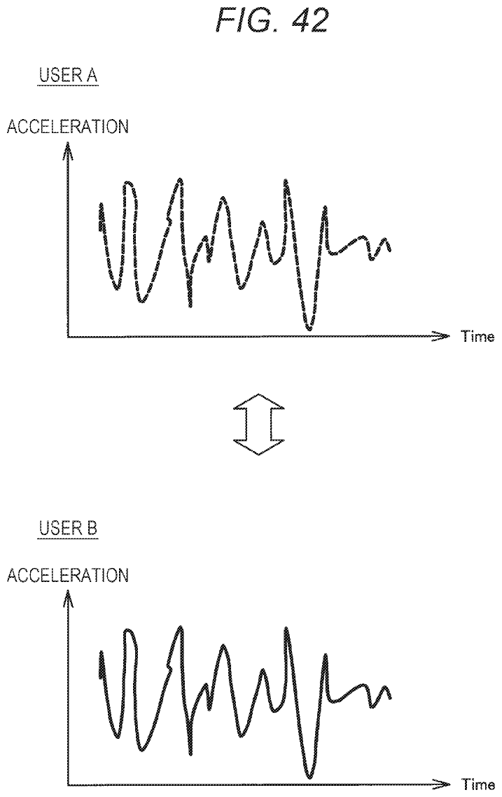

With reference to FIG. 41, a hardware configuration of the device 100 according to the embodiment of the present disclosure will be described. FIG. 41 is a block diagram illustrating a hardware configuration example of the device 100 according to an embodiment of the present disclosure.

As illustrated in FIG. 9, the device 100 includes sensors such as the acceleration sensor 111, the gyro sensor 113, or the geomagnetic sensor 115. As other sensors, for example, various sensors or the like such as an angular velocity sensor, an illuminance sensor, a temperature sensor, an atmospheric pressure sensor, or a sound sensor (microphone) may be included. The sensors obtain information regarding the state of the device 100 itself such as attitude of a casing of the device 100, and information regarding surrounding environment of the device 100 such as brightness and noise around the device 100, for example. A detection value of the sensor unit 110 is A/D converted by an A/D converter 905 and input to a control unit 910.

Furthermore, the device 100 includes a communication apparatus which is a communication interface including a communication device or the like for connecting to a communication network, in order to obtain absolute position information. The communication apparatus can be, for example, a communication card, etc., for local area network (LAN), Bluetooth (registered trademark), Wi-Fi, or a wireless USB (WUSB). Furthermore, the communication apparatus may be a router for optical communication, a router for asymmetric digital subscriber line (ADSL), a modem for various communication, or the like. Furthermore, the device 100 may include a GPS receiver that receives a global navigation satellite system(s) (GNSS) signal and measures the latitude, longitude, and altitude of the device. FIG. 41 includes description of a speech antenna 181, a Wi-Fi antenna 182, and a GPS antenna 183. Signals obtained by the individual antennas 181, 182, and 183 are input to the control unit 910.

The control unit 910 includes a central processing unit (CPU) 911, a read only memory (ROM) 912, and a random access memory (RAM) 913, and a nonvolatile memory 914. The CPU 911 functions as an arithmetic processing unit and a control apparatus, and controls all or part of operation in the device 100 in accordance with various programs recorded in the ROM 912, the RAM 913, and the nonvolatile memory 914. The ROM 912 stores programs, calculation parameters, or the like, used by the CPU 911. The RAM 913 primarily stores programs to be used in the execution by the CPU 911 or parameters, or the like, appropriately changing in execution of the programs. The CPU 911, the ROM 912, the RAM 913, and the nonvolatile memory 914 are mutually connected via a host bus 915. Note that the device 100 may include a processing circuit such as a digital signal processor (DSP), an application specific integrated circuit (ASIC), or a field-programmable gate array (FPGA) in place of or in addition to the CPU 911.

Furthermore, the host bus 915 is connected to an external bus (not illustrated) such as a peripheral component interconnect/interface (PCI) bus via a bridge (not illustrated). The device 100 may include an operation unit 921, an output unit 922, an external I/F923, or the like connected via the external bus. The operation unit 921 is a device that is operated by the user, such as a mouse, a keyboard, a touch panel, buttons, a switch, and a lever, for example. The operation unit 921 may be, for example, a remote control device utilizing infrared rays or other radio waves. The operation unit 921 includes an input control circuit that generates an input signal on the basis of the information input by the user and outputs the generated input signal to the CPU 911. The user operates the operation unit 921, thereby inputting various data to the device 100 or giving an instruction on processing operation to the device 100.

The output unit 922 includes a device capable of notifying the user of obtained information using a sense such as visual sense, auditory sense, or tactile sense. The output unit 922 can be, for example, a display device including a nonvolatile display such as an electronic paper or a memory liquid crystal display and a MEMS display, an audio output device such as a speaker or a headphone, a vibrator, or the like. The output unit 922 outputs a result obtained by processing of the device 100 as a video including a text or an image, sound such as voice or sound, vibration, or the like.

The external I/F 923 is a port for connecting equipment to the device 100. The external I/F 923 can be, for example, a universal serial bus (USB) port, an IEEE 1394 port, a small computer system interface (SCSI) port, or the like. Furthermore, the external I/F 923 may be an RS-232C port, an optical audio terminal, a High-Definition Multimedia Interface (HDMI) (registered trademark) port, or the like. Connecting externally connected equipment to the external I/F 923 enables various data to be exchanged between the device 100 and the externally connected equipment.

An example of the hardware configuration of the device 100 has been described above. Each of the above-described constituents may use general-purpose members, or may use hardware specialized for the function of each of the constituents. Such a configuration can be appropriately changed in accordance with the technical level at the time of implementation. Furthermore, the server 200 included in the information processing system 1 of the present embodiment can be implemented by an apparatus having an equivalent hardware configuration.

### 5. Supplement

(5.1. Feature Amount Other than Relative Trajectory)

The above embodiment has described a case where the positional sameness determination is performed on the basis of the relative trajectory identified by the detection value obtained by the inertial sensor. Alternatively, however, the present disclosure can execute the positional sameness determination processing in a similar manner even with a feature amount other than the relative trajectory.

For example, the positional sameness determination may be performed by using original time-series data of the detection value of the sensor. For example, as illustrated in FIG. 42, in a case where time-series data of the detection value of the acceleration sensor has been obtained, the similarity of the waveforms of the time-series data for a predetermined time may be compared with each other so as to perform sameness determination of the above embodiment.

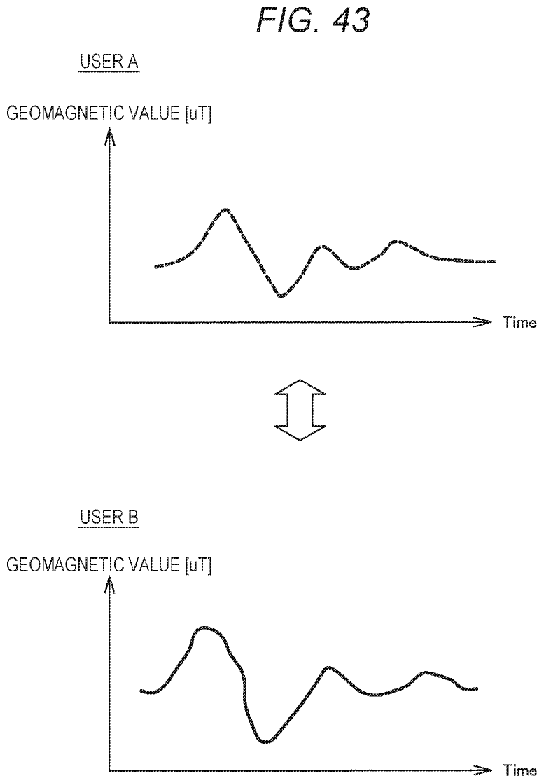

Alternatively, as illustrated in FIG. 43, instead of using time-series data of detection values obtained by an inertial sensor such as an acceleration sensor or a gyro sensor, the similarity of waveforms of time-series data of environmental sensors such as a geomagnetic sensor, and an atmospheric pressure sensor may be compared with each other so as to perform sameness determination of the above embodiment. Examples of other environmental sensors include an atmospheric pressure sensor, a temperature sensor, a humidity sensor, a wind speed sensor, a microphone, and the like. For example, in FIG. 43 is comparison of time-series data of magnetic values obtained by a geomagnetic sensor. The indoor space of a reinforced building often has an inherent magnetic pattern that depends on each of locations. Accordingly, it is expected that the positional sameness determination can be performed with high accuracy by using detection value obtained by the geomagnetic sensor. Note that geomagnetic sensors have monotonous magnetic patterns outdoors, and thus, suitable for indoor use. It is considered that useful data can be obtained by using an appropriate environmental sensor according to the environment.

(5.2. User Agreement on Information Collection)

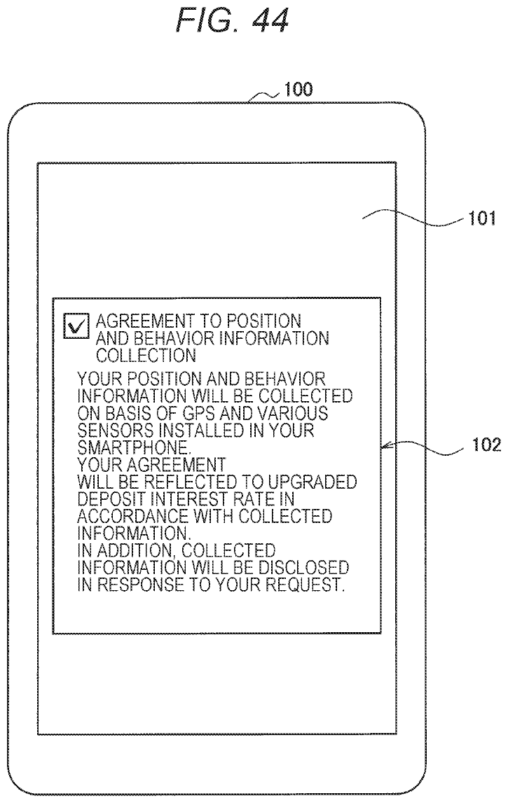

In the information processing system 1 according to the above embodiment, it is necessary to collect information to identify the user's behavior obtained by the device 100. In operation of the information processing system 1, it is desirable to obtain agreement from the user on collection of information for identifying behavior, such as position information and time information, for example. For example, as illustrated in FIG. 44, user agreement on information collection may be received by displaying an information collection agreement screen 102 on a display 101 of the device 100 held by the user and asking the user to mark on a check box. At this time, an incentive for agreement on information collection may be presented to the user. For example, in a case where there is a bank account opened by the user, as illustrated in FIG. 44, it is conceivable to make a proposal that your agreement on information collection will be reflected to upgraded deposit interest, and so on.

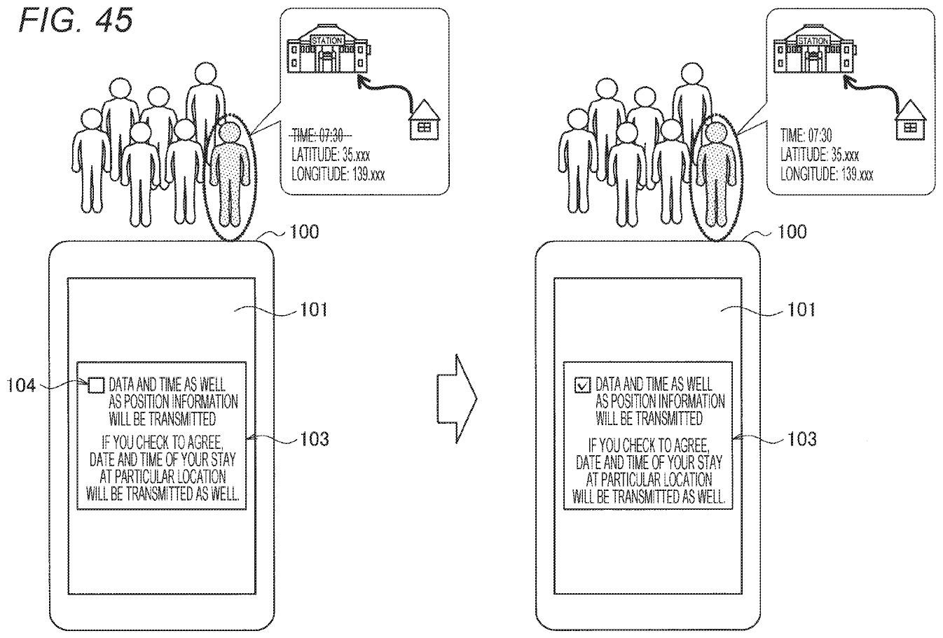

Furthermore, in the above embodiment, the absolute time (date and time) is not necessarily needed for identification of the absolute position information of the user. Still, acquisition of the absolute time would make it possible to distinguish whether or not a user is during lunch or dinner in a case where the user is in a restaurant, for example, leading to an increase in information amount of behavior to be recognized. Accordingly, as illustrated in FIG. 45, an absolute time transmission agreement screen 103 may be displayed on the display 101 of the device 100 so that the user can select whether or not to allow transmission of the absolute time. In the left illustration of FIG. 45, the check box on the absolute time transmission agreement screen 103 is unchecked, and thus, the absolute time is not going to be transmitted to the server 200. In contrast, in the right illustration of FIG. 45, the check box of the absolute time transmission agreement screen 103 is checked, and thus, the absolute time is going to be transmitted to the server 200.

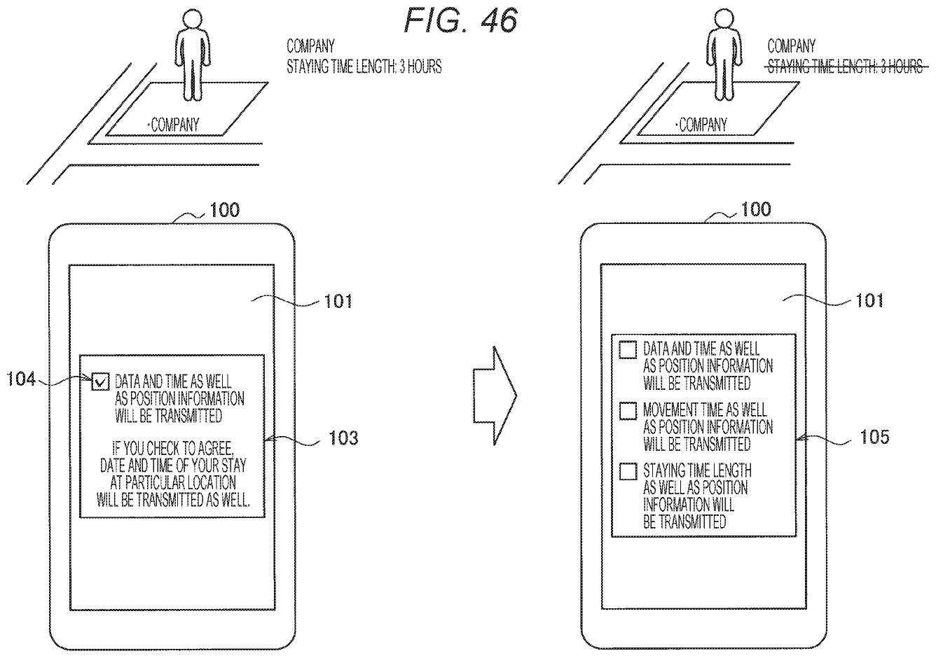

While FIG. 45 confirms whether or not the absolute time of the user is to be transmitted, it is also possible to confirm with the user whether or not to permit transmission of simply relative time such as the travel time without transmitting the absolute time. For example, as in the left illustration of FIG. 46, in a case where the check box of the absolute time transmission agreement screen 103 is checked, the absolute time is going to be transmitted. In a case where the absolute time transmission agreement screen 103 is unchecked, as in the right illustration of FIG. 46, it is possible to display a relative time transmission agreement screen 105 for confirming whether or not to permit transmission of the relative time. For example, the relative time transmission agreement screen 105, may display, for example, a case where the absolute time is to be transmitted to the server 200, a case where the relative time alone is to be transmitted to the server 200, a case where the staying time length alone is to be transmitted to the server 200, or the like. The device 100 transmits the information checked on the relative time transmission agreement screen 105 to the server 200. In a case where all the check boxes on the relative time transmission agreement screen 105 is unchecked, information regarding time is not to going to be transmitted to the server 200.

In a case where the travel time and the staying time length are transmitted to the server 200, there is a case where the user's behavior can be estimated even without transmission of the absolute time. For example, here is an exemplary case where a user stays in the company for three hours, thereafter travels to a restaurant over five minutes, and stayed in a restaurant for 15 minutes. At this time, for example, in a case where the user behavior in the restaurant is estimated to be eating lunch by the method of the third embodiment, the staying time in the restaurant is estimated to be around 12:00. Subsequently, it is also possible to estimate that the user was in the company in the morning by calculating back from the estimated staying time.

Hereinabove, the preferred embodiments of the present disclosure have been described above with reference to the accompanying drawings, while the technical scope of the present disclosure is not limited to the above examples. A person skilled in the art in the technical field of the present disclosure may find it understandable to reach various alterations and modifications within the technical scope of the appended claims, and it should be understood that they will naturally come within the technical scope of the present disclosure.

In addition, the effects described in this specification are merely illustrative or exemplary, and are not limiting. That is, the technology according to the present disclosure can exhibit other effects obvious to those skilled in the art from the description of the present specification together with the above effects or in place of the above effects.

Note that the following configuration should also be within the technical scope of the present disclosure.

(1)

An information processing apparatus including a determination unit that determines similarity of positions of a plurality of users on the basis of time-series data that can identify a movement state of each of the plurality of users, obtained for each of the plurality of users.

(2)

The information processing apparatus according to (1),

in which the determination unit determines similarity of the positions of the users on the basis of the time-series data in a same area.

(3)

The information processing apparatus according to (1) or (2),

in which the determination unit performs positional sameness determination on the plurality of users on the basis of a relative trajectory obtained on the basis of the time-series data.

(4)

The information processing apparatus according to any one of (1) to (3),

in which the determination unit includes:

a synchronization processing unit that achieves synchronization between each of pieces of the time-series data with the two pieces of time-series data as determination targets;

a deviation degree calculation unit that calculates a deviation degree of the synchronized time-series data; and

a determination processing unit that determines similarity of positions of the users on the basis of the calculated deviation degree.

(5)

The information processing apparatus according to (4),

in which the synchronization processing unit

segments each of pieces of time-series data by a predetermined scale unit,

normalizes a scale of each of pieces of the time-series data for each of the segmented periods, and

performs synchronization while aligning data start positions of one of the pieces of time-series data as a reference with the other of the pieces of time-series data for each of the periods.

(6)

The information processing apparatus according to any one of (1) to (5),

in which the time-series data is a detection value of an inertial sensor.

(7)

The information processing apparatus according to any one of (1) to (5),

in which the time-series data is a detection value of an environmental sensor.

(8)

The information processing apparatus according to any one of (1) to (7), further including an absolute position information acquisition unit that obtains absolute position information indicating an absolute position of the user.

(9)

The information processing apparatus according to any one of (1) to (8), further including an attribute identification unit that decides attributes of one user and another user on the basis of absolute information of at least the one user among the plurality of users determined to have similar positions.

(10)

The information processing apparatus according to (1), further including an attribute identification unit that identifies an attribute of the user,

in which the attribute identification unit

identifies behavior of the user

on the basis of location attribute information based on a staying time at the position calculated for the users determined to have similar positions and on the basis of a location attribute table including setting of information regarding the staying time indicating the behavior of the user.

(11)

The information processing apparatus according to (10),

in which the location attribute table includes setting of the staying time and staying time length of the user, implemented at the location.

(12)

The information processing apparatus according to (10) or (11),

in which the attribute identification unit updates the location attribute table on the basis of position information and behavior-related information obtained from at least one user among the users determined to have similar positions.

(13)

The information processing apparatus according to any one of (10) to (12),

in which the attribute identification unit identifies a social attribute of the user on the basis of a result of comparison between the location attribute information of the user and the identified location attribute table.

(14)

The information processing apparatus according to any one of (10) to (13),

in which the attribute identification unit identifies the social attribute of the user on the basis of the location attribute information of the user and a social attribute table representing the social attribute of the user.

(15)

An information processing method including:

obtaining, by using a sensor, time-series data that can be used to identify a movement state of each of a plurality of users, for each of the users; and determining, by using a processor, similarity of positions of the users on the basis of the time-series data.

(16)

A computer program causing a computer to function as an information processing apparatus including a determination unit that determines similarity of positions of a plurality of users on the basis of time-series data that can be used to identify a movement state of each of the plurality of users, obtained for each of the plurality of users.

### REFERENCE SIGNS LIST

1 Information processing system
100 Device
110 Sensor unit
111 Acceleration sensor
113 Gyro sensor
115 Geomagnetic sensor
120 Trajectory calculation unit
130 Absolute position information acquisition unit
140 Area determination unit
150 Attribute information acquisition unit
160 Transmission unit
170 Reception unit
200 Server
210 Data acquisition unit
220 Positional sameness determination unit
230 Attribute identification unit
240 Output unit
250 Obtained data storage unit
260 Analysis result storage unit
270 Location attribute table storage unit
280 Social attribute table storage unit

1. An information processing apparatus comprising a determination unit that determines similarity of positions of a plurality of users on a basis of time-series data that can identify a movement state of each of the plurality of users, obtained for each of the plurality of users.

2. The information processing apparatus according to claim 1,
wherein the determination unit determines similarity of the positions of the users on a basis of the time-series data in a same area.

3. The information processing apparatus according to claim 1
wherein the determination unit performs positional sameness determination on the plurality of users on a basis of a relative trajectory obtained on a basis of the time-series data.

4. The information processing apparatus according to claim 1,
wherein the determination unit includes:
a synchronization processing unit that achieves synchronization between each of pieces of the time-series data with the two pieces of time-series data as determination targets;
a deviation degree calculation unit that calculates a deviation degree of the synchronized time-series data; and
a determination processing unit that determines similarity of positions of the users on a basis of the calculated deviation degree.

5. The information processing apparatus according to claim 4,
wherein the synchronization processing unit
segments each of pieces of time-series data by a predetermined scale unit,
normalizes a scale of each of pieces of the time-series data for each of the segmented periods, and
performs synchronization while aligning data start positions of one of the pieces of time-series data as a reference with the other of the pieces of time-series data for each of the periods.

6. The information processing apparatus according to claim 1, wherein the time-series data is a detection value of an inertial sensor.

7. The information processing apparatus according to claim 1, wherein the time-series data is a detection value of an environmental sensor.

8. The information processing apparatus according to claim 1, further comprising an absolute position information acquisition unit that obtains absolute position information indicating an absolute position of the user.

9. The information processing apparatus according to claim 1, further comprising an attribute identification unit that decides attributes of one user and another user on a basis of absolute information of at least the one user among the plurality of users determined to have similar positions.

10. The information processing apparatus according to claim 1, further comprising an attribute identification unit that identifies an attribute of the user,
wherein the attribute identification unit
identifies behavior of the user
on a basis of location attribute information based on a staying time at the position calculated for the users determined to have similar positions and on a basis of a location attribute table including setting of information regarding the staying time indicating the behavior of the user.

11. The information processing apparatus according to claim 10,
wherein the location attribute table includes setting of the staying time and staying time length of the user, implemented at the location.

12. The information processing apparatus according to claim 10,
wherein the attribute identification unit updates the location attribute table on a basis of position information and behavior-related information obtained from at least one user among the users determined to have similar positions.

13. The information processing apparatus according to claim 10,
wherein the attribute identification unit identifies a social attribute of the user on a basis of a result of comparison between the location attribute information of the user and the identified location attribute table.

14. The information processing apparatus according to claim 10,
wherein the attribute identification unit identifies the social attribute of the user on a basis of the location attribute information of the user and a social attribute table representing the social attribute of the user.

15. An information processing method comprising:
obtaining, by using a sensor, time-series data that can be used to identify a movement state of each of a plurality of users, for each of the users; and
determining, by using a processor, similarity of positions of the users on a basis of the time-series data.

16. A computer program causing a computer to function as an information processing apparatus including a determination unit that determines similarity of positions of a plurality of users on a basis of time-series data that can be used to identify a movement state of each of the plurality of users, obtained for each of the plurality of users.
